(19) United States
(12) Patent Application Publication
(10) Pub. No.: US 2010/0063629 A1
(43) Pub. Date: Mar. 11, 2010

(54) SYSTEM AND METHOD FOR RECIRCULATING PARTS

(75) Inventors: Mark Andrew Battisti, Dayton, OH (US); Dennis Joseph Ashurst, Beavercreek, OH (US); Stephen Harris, Dayton, OH (US)

Correspondence Address: MATTHEW R. JENKINS, ESQ., 2310 FAR HILLS BUILDING, DAYTON, OH, 45419, US

(73) Assignee: RIXAN ASSOCIATES, INC., Dayton, OH (US)

(21) Appl. No.: 12/207,787

(22) Filed: Sep. 10, 2008

(51) Int. Cl. G05B 19/00

(52) U.S. Cl. 700/259

(57) ABSTRACT

This invention relates to a system and method for feeding and recirculating parts for vision-based pickup. The system and method have a feeder that automatically recirculates parts that are not picked by a robot. The system has a feeder bowl, ramp and interchangeable picking plate, all of which may be vibrated to both feed parts and cause recirculation.

### BACKGROUND OF THE INVENTION

1. Field of the Invention

This invention relates to a system and method for feeding parts, and more particularly to a system and method for feeding parts with automatic recirculation of parts.

2. Description of the Related Art

In the past, automated robots, such as the Melfa® brand of robots available from the assignee, Rixan Associates, Inc. of Dayton, Ohio, provide multi-axis capability of picking one or more parts from a picking area and moving those parts to another area where they may be placed by the robot for further processing, assembly or the like. Oftentimes, it is necessary to have the part properly oriented for picking by the robot. Parts that are at a picking area that are not properly oriented cannot be picked by the robot. These parts have to be manually or mechanically manipulated into proper orientation which slows down feeding and processing of the parts.

In many prior art robotic systems, cameras and imaging systems, such as those used with the Melfa® line of robots, have provided imaging of parts at a picking area so that the robot knows which parts to pick. Unfortunately, the parts that are not properly oriented cannot be picked at the picking area and have to be moved out of the picking area to clear the way for parts that are properly oriented.

Some methods and systems have attempted to overcome this problem by causing the parts to be situated on a belt that is passed underneath the camera. The belt stops and the robot then picks parts that are properly oriented, while the parts that are not properly oriented remain on the belt. The belt is actuated so that more parts can be placed under the image system so that the robot can pick the properly oriented parts. The non-properly oriented parts that remain on the belt are transferred downstream until ultimately they fall off an end of the belt and into a storage device, such as a bucket. The bucket is lifted and its contents delivered back onto the belt upstream of the imaging area. Alternatively, the upstream end may have an automated platform or bucket that receives the parts from the second belt and then the bucket is automatically or mechanically raised and its contents of parts are then dumped back onto the first belt.

In some prior art systems, a second belt that moves the parts toward the upstream end of the first belt is provided so that the parts can be passed under the camera again.

Other systems include the use of vibration in place of a belt, but those systems do not recirculate parts and they typically require additional mechanisms to recirculate parts that are not picked by a robot.

Unfortunately, the prior art systems required multiple moving parts, increased transitional surfaces, pinch points and jams, belts and the like which required increased maintenance and cost.

What is needed, therefore, is a system and method which overcomes some of the deficiencies of the prior art and simplifies the process for circulating parts to a robot picking area.

### SUMMARY OF THE INVENTION

In one aspect, this invention comprises a system and method for recirculating parts to a picking area for picking by a robot.

In another aspect, a system and method is provided for automatic recirculation of parts.

In still another aspect, a system and method is provided that utilizes a drive to both drive parts from a first level to a second level and also causes parts to be transferred back from the second level to the first level for recirculation.

In yet another aspect, the invention comprises a system and method for providing a vibrating feeder that causes parts to be vibrated to a picking area and any parts that are either not desired to be picked or in an improper orientation are caused to be recirculated by the vibratory feeder.

In still another aspect, the invention comprises a system for feeding parts comprising at least one controller, a part feeder having a reservoir area and a picking area, the picking area being an area for supporting parts to be picked, a robot coupled to the at least one controller and having an arm for picking at least one properly-oriented part at the picking area and at least one vibrator for vibrating the part feeder so that parts are fed by vibration from the reservoir area to the picking area, an imaging system coupled to the at least one controller for capturing at least one image of the picking area and generating image data in response thereto, the at least one controller energizing the at least one vibrator to vibrate the part feeder in response to the image data to cause parts to move to the picking area during a part feeding period and thereafter energizes the imaging system to capture at least one subsequent image of the picking area and generate the image data in response thereto, the at least one controller using the image data to determine if the at least one properly-oriented part is located at the picking area and if it is, energizing the robot to cause the arm to pick the at least one properly-oriented part in response thereto and transfer it from the picking area to a part drop-off area, wherein the at least one vibrator causes the parts to first move from the reservoir area to the picking area and for those parts that are not properly oriented at the picking area to be recirculated from the picking area to the reservoir area in response to the vibration.

In still another aspect, the invention comprises a system for feeding parts comprising a feeder bowl, the feeder bowl having a reservoir area for receiving parts, a picking surface and a ramp coupling the reservoir area to the picking surface, at least one vibrator coupled to the feeder bowl for vibrating the feeder bowl to cause parts to move on the ramp from the reservoir area to the picking surface, an imaging system for capturing at least one image of the picking surface and generating image data in response thereto and a robot for picking predetermined ones of the parts from the picking surface in response to the image data, the picking surface being adapted and situated relative to the reservoir area so that at least some parts on the picking surface that are not the predetermined ones of the parts are recirculated into the reservoir area during vibration of the feeder bowl.

In another aspect, the invention comprises a part feeder for use with a robot and imaging system, the part feeder comprising a feeder bowl, the feeder bowl having a reservoir area for receiving parts, a picking surface and a ramp coupling the reservoir area to the picking surface, at least one vibrator coupled to the feeder bowl for vibrating the feeder bowl to cause parts to move on the ramp from the reservoir area to the picking surface, the picking surface being adapted and situated relative to the reservoir area so that at least some parts on the picking surface that are not picked by the robot are recirculated into the reservoir area during vibration of the feeder bowl.

In another aspect, the invention comprises a method for feeding parts to a robot comprising the steps of providing a feeder bowl having a reservoir area and a picking surface for supporting parts, at least one of the parts being a desired part to be picked by the robot and vibrating the picking surface to cause parts on the picking surface that have not been picked by the robot to be recirculated from the picking surface to the reservoir area during the vibration.

In another aspect, the invention comprises a system for feeding parts to a robot comprising a part feeder having a reservoir area and a picking surface for supporting parts, at least one of the parts being a desired part to be picked by the robot; and at least one vibrator for vibrating the picking surface to cause parts other than the desired part to be recirculated from the picking surface to the reservoir area.

In another aspect, one embodiment comprises a system for feeding parts to a robot comprising a part feeder having a reservoir area and a picking surface for supporting parts, at least one of the parts being a desired part to be picked by the robot and at least one mover or driver for causing parts other than the desired part to be recirculated from the picking surface to the reservoir area. This embodiment may be used alone or in combination with one or more of the following features:

wherein the at least one mover or driver comprises at least one vibrator for vibrating the picking surface to cause parts other than the desired part to be recirculated from the picking surface to the reservoir area;

wherein the at least one mover or driver comprises at least one curved support for enabling parts to move from the reservoir area to the picking surface;

wherein the at least one curved support defines a ramp for enabling parts to travel from the reservoir to the picking surface;

wherein the at least one curved support defines a driven belt having a first portion associated with the reservoir and a second portion that defines the picking surface, the system further comprising a belt driver for driving the belt to cause parts to move from the reservoir to picking surface, the belt being adapted to permit parts that are not picked by the robot to recirculate into the reservoir;

wherein the system comprises at least one vibrator for vibrating the picking surface to cause parts other than the desired part to be recirculated from the picking surface to the reservoir area;

wherein the system further comprises an imaging system for capturing at least one image of the picking surface and generating image data in response thereto, at least one controller for energizing the at least one vibrator to vibrate ramp during a part feeding period until the desired part becomes situated on the picking surface in response to the image data;

wherein the at least one controller ceases energizing the at least one vibrator and thereafter energizes the imaging system to capture the at least one image of the picking surface and generate the image data in response thereto, the robot receiving the image data from the at least one controller and causing the robot to pick the desired part in response thereto and transfer it from the picking surface to a part drop-off area;

wherein the robot is coupled to the imaging system and causes the imaging system to capture the at least one image of the picking surface and generate the image data in response thereto, the robot receiving the image data and causing the robot to pick the desired part in response thereto and transfer it from the picking surface to a part drop-off area;

wherein the picking surface comprises at least one edge over which parts may be recirculated into the reservoir, the at least one edge being contained within an imaginary plane of at least one reservoir wall defining the reservoir area;

wherein the picking surface is generally planar and situated entirely above the reservoir area so that parts may fall off of it into the reservoir area;

wherein the system comprises a plate that defines the picking surface, the plate being removably secured to the feeder bowl;

wherein the picking surface is interchangeable with at least one second picking surface selected in response to the parts to be picked by the robot;

wherein the picking surface comprises a preselected surface adapted to improve at least one of movement of parts on the surface or imaging of parts on the surface;

wherein the preselected surface comprises stainless steel plate, translucent polycarbonate, Brushlon, hard anodized aluminum, foam, or textured surface;

wherein the preselected surface comprises a predetermined color to facilitate capturing the at least one image;

wherein the predetermined color comprises black, silver, white or translucent to facilitate grayscale contrast;

wherein the vibration causes the parts to be recycled from the picking surface to the reservoir when the robot is not picking the desired part and ceases vibration of the picking surface when the robot is picking parts from the picking surface;

wherein the picking surface is adapted to improve both movement of parts on the picking surface during the vibration and preventing movement of the parts on the picking surface during imaging;

wherein the part feeder comprises a ramp coupling the reservoir area to the picking surface;

wherein the ramp defines a helix and comprises an inlet associated with the reservoir area and an outlet in operative relationship with the picking surface, the outlet being vertically higher than the inlet, the at least one vibrator causing the parts to travel by vibration from the reservoir area into the inlet, along the ramp where they can exit the outlet and onto the picking surface;

wherein the system further comprises a feed control for controlling flow or movement of parts onto the picking surface;

wherein the system further comprises a feed control for controlling flow of parts from the reservoir area to the picking surface, the feed control comprises an adjustable feeder gate in operative relationship with the outlet of the ramp;

wherein the system further comprises a sensor for sensing parts upstream of the picking surface and generating a low parts level signal in response thereto when a quantity of parts falls below a predetermined parts level, the at least one vibrator vibrating the picking surface in response to the low parts level signal;

wherein the system further comprises a feed hopper for feeding parts from a hopper area to the part feeder, the feed hopper having at least one feed hopper vibrator for vibrating the feed hopper and causing parts to be delivered to the part feeder in response to the low parts level signal;

wherein the feed hopper comprises a door and at least one driver coupled to the door for driving the door to an open position in response to the low parts level signal;

wherein the at least one vibrator causes the parts to move onto the picking surface during a predetermined feeding period, the at least one feed hopper vibrator vibrating the feed hopper for a feed hopper vibrator period that is less than or equal to the part feeding period;

wherein the desired part to be picked has a common characteristic, at least some of the parts on the feeding surface not having the common characteristic;

wherein the common characteristic is a position, proper orientation, shape or size of the desired part;

wherein the system comprises at least one light source for illuminating the picking surface;

wherein the at least one light source provides indirect white light;

wherein the at least one light source provides light other than white light;

wherein the at least one light source provides polarized red light;

wherein the system comprises at least one light source for illuminating the picking surface with either polarized or non-polarized light when the imaging system captures the image;

wherein the part feeder comprises a bowl having an aperture, the system comprises at least one light source for transmitting light through the aperture and illuminating the picking surface from underneath the picking surface;

wherein the system comprises at least one controller causes the imaging system to capture an image of the picking surface in response to a feed request from the robot and if the desired part is not located on the picking surface, the at least one controller energizes the at least one vibrator for a predetermined vibration period to cause parts to be moved onto the picking surface;

wherein after the predetermined vibration period, the at least one controller causes the imaging system to capture another image of the picking surface and if at least one desired part is situated on the picking surface, the at least one controller ceases energizing the at least one vibrator;

wherein the part feeder comprises a feeder bowl, the feeder bowl comprising an auto tuner associated with the feeder bowl for tuning the feeder bowl in response to at least one of a size, shape, weight of the parts being processed or mass of the feeder bowl;

wherein the auto tuner comprises an accelerometer mounted to the bowl;

wherein the system comprises at least one controller, the at least one controller comprising an auto mode during which it energizes the imaging system to capture the at least one image of the picking surface at predetermined intervals and provides the image data to the robot so that the robot can pick at least one desired part from the picking surface;

wherein the system comprises at least one controller and a robot controller coupled to the at least one controller for controlling the robot, the robot controller causing the imaging system to capture the at least one image and generating a feed request signal in response thereto if at least one desired part is not located on the picking surface and the at least one controller energizing the at least one vibrator in response thereto;

wherein the at least one vibrator comprises at least one electromagnetic drive;

wherein the system comprises a plurality of leaf springs on which the feeder bowl is mounted, the electromagnetic drive being operatively associated with the plurality of leaf springs to cause the vibration;

wherein the at least one controller comprises an imaging system calibrator for calibrating the imaging system with information regarding the desired part.

In another aspect, another embodiment comprises a feeder for feeding parts to a robot, said feeder comprising a floor and wall that defines a reservoir area for receiving parts, a picking surface defining a picking area for the robot to pick either predetermined ones of said parts or parts that are properly oriented from parts that are situated on the picking surface, and a recirculator for causing parts not picked by said robot to move from said reservoir area to said picking surface and substantially simultaneously automatically cause parts to be recirculated from said picking surface to said reservoir area. This embodiment may be used alone or in combination with one or more of the following features:

wherein said picking surface lies within a first imaginary plane and said floor of said feeder lies in a second imaginary plane, wherein said first imaginary plane is vertically raised relative to said second imaginary plane;

wherein said picking surface comprises an edge over which parts may fall, said edge being contained within an imaginary plane of said wall defining said reservoir area;

wherein said picking surface is generally planar and situated entirely above said reservoir area so that parts may fall off of said picking surface and recirculate into said reservoir area;

wherein said picking surface is removably secured to said feeder bowl;

wherein said feeder comprises a ramp and at least one vibrator for vibrating the ramp to cause parts to vibrate and move on said ramp from said reservoir area to said picking surface and from said picking surface to said reservoir area;

wherein said feeder comprises a ramp and at least one vibrator for vibrating the ramp to cause parts to vibrate and move on said ramp from said reservoir area to said picking surface and from said picking surface to said reservoir area;

wherein said feeder comprises a driven member coupled to a driver for causing parts to be moved from said reservoir area to said picking surface and from said picking surface to said reservoir area;

wherein said driven member comprises at least one ramp and said driver comprises at least one vibrator for vibrating the ramp to cause parts to vibrate and move on said ramp from said reservoir area to said picking surface and from said picking surface to said reservoir area;

wherein said driven member comprises at least one belt and said driver comprises at least one belt driver for driving said at least one belt to transporting parts from said reservoir area to said picking surface and from said picking surface to said reservoir area;

wherein an area of said at least one belt defines said picking surface.

These and other objects and advantages of the invention will be apparent from the following description, the accompanying drawings and the appended claims.

### BRIEF DESCRIPTION OF THE DRAWINGS

FIG. 1 is a schematic view of one embodiment of the feeding system;

FIG. 2 is a perspective view of the embodiment shown in FIG. 1;

FIG. 3 is a fragmentary view showing the feeding bowl and a spiral or helical ramp;

FIG. 4 is a view similar to FIG. 3 showing the bowl with illustrative parts therein;

FIG. 5 is a view similar to FIG. 4 showing parts after they have been vibrated to a picking area or picking station;

FIG. 6 is a view showing the removable picking plate;

FIG. 7 is a view illustrating a robotic arm picking a part from the picking plate;

FIG. 8 is a view of the arm retracting from the picking area after it has picked a part;

FIG. 9 is a view of the robotic arm moving toward another area where the part will be delivered;

FIG. 10 is view of the arm dropping the part to an area where it is to be delivered;

FIG. 11 is a schematic illustration of one mode of operation of the system;

FIG. 12 is a schematic view of data sharing among various components in the system;

FIG. 13 is a view taken on line 13-13 in FIG. 2 showing various details of the imaging system, a camera and lights;

FIG. 14A is a view of a removable plate for calibrating the robots;

FIG. 14B is an enlarged view of four parts after they have been moved from initial calibration positions to four desired calibration positions;

FIG. 14C is a screen shot of a user interface for enabling a user to enter coordinates of points of calibration parts directly into a calibration program for calibrating the robot;

FIG. 14D illustrates a view of a user interface for specifying a reference point on an image of the calibration parts;

FIGS. 15A-15B illustrate another bowl for use in the system;

FIGS. 16A-16H show various details of the components of the bowl shown in FIGS. 15A-15B, with FIG. 16B being a section taken along the line 16B-16B in FIG. 16A;

FIG. 17A is a perspective view of the bowl according to the embodiment shown in FIG. 15A;

FIG. 17B is another perspective view of the bowl shown in FIGS. 15A and 17A, illustrating a calibration plate with cross markings for use by the system for calibrating;

FIG. 17C is another perspective view of the bowl shown in FIGS. 15A and 17A illustrating a light source for illuminating a transparent plate and thereby providing underneath lighting in the illustration shown;

FIGS. 17D-17E are fragmentary sectional views illustrating various features of another embodiment illustrating a detachable plate having a non-textured surface supported by a compression system that enables the surface to move in a vertical direction;

FIG. 18 is a section view taken along the line 18-18 in FIG. 15A;

FIG. 19A is a view of another embodiment illustrating a recirculator having an endless belt for moving parts to a picking area on the belt and also causing the unpicked parts to fall off an end of the belt so that they can be recirculated, thereby providing a single source for recirculating and moving parts; and

FIG. 19B is a sectional view illustrating various details of the operative upstream and downstream areas of the recirculator illustrated in the embodiment shown in FIG. 19A.

### DETAILED DESCRIPTION OF PREFERRED EMBODIMENTS

Referring now to the Figures, a system 10 and method are shown for automated feeding of parts, such as parts 28 (FIG. 4), to a robot 30. The system 10 comprises a feed controller 12 for controlling the operation of the system 10. The system 10 further comprises a part feeder 14 having a frame 16 for supporting a feeding bowl 18 above the ground and in operative relationship with a robot 30.

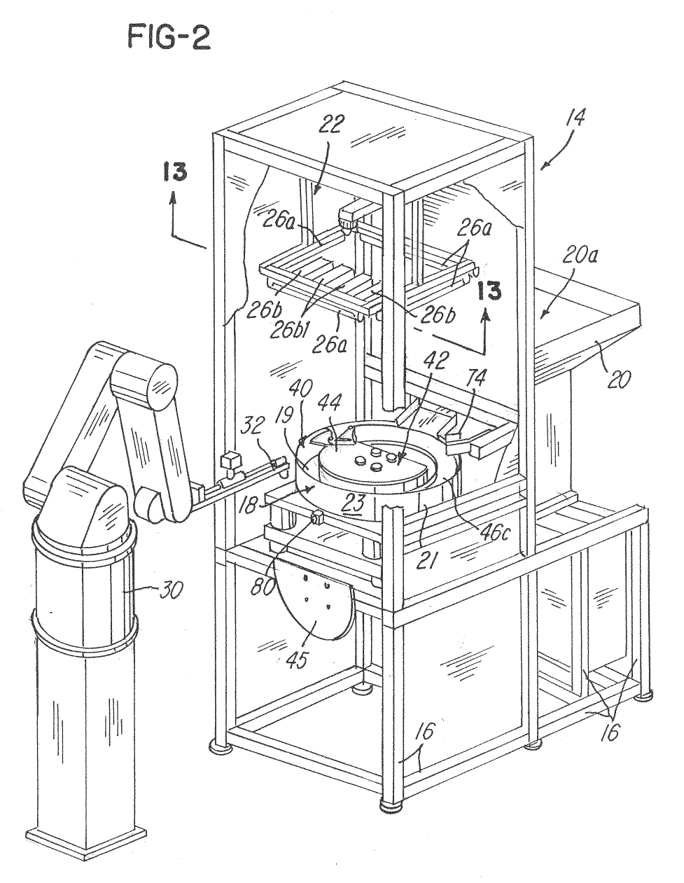

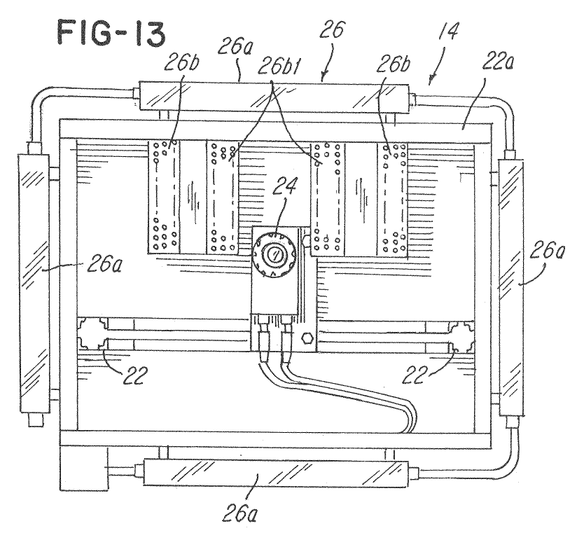

The frame 16 also comprises an image system support 22 coupled to and supporting a frame 22a (FIG. 13) onto which a camera or image system 24 is conventionally mounted. The image system 24 comprises an image controller 36, a camera or image system 24 mounted to the image system support 22 above the feeding bowl 18 and at least one or a plurality of light sources 26 (FIGS. 2 and 13) for providing light. In this illustration, various types of light may be used, such as white or fluorescent light 26a, polarized red light 26b, a polarizing filter 26b1 or polarized LEDs (FIG. 13) in the illustration. For example, the polarizing filter could be a polarizing film that is attached to and covers the fluorescent light 26a. As described later herein, the type of light used during image capture will be selected by the user depending upon the parts 28 being processed.

In the illustration being described, the parts 28 being processed are illustrated in FIG. 4 as cylindrical parts 28, but it should be understood that the part feeder 14 could be used to accommodate an infinite variety of parts 28, especially parts of 50 mm in length or less. Accordingly, while the parts 28 are illustrated as being cylindrical parts 28 for ease of illustration, it should be understood that they could be other sizes, shapes and configurations if desired. Also, parts 28 may comprise different materials, weights and dimensions.

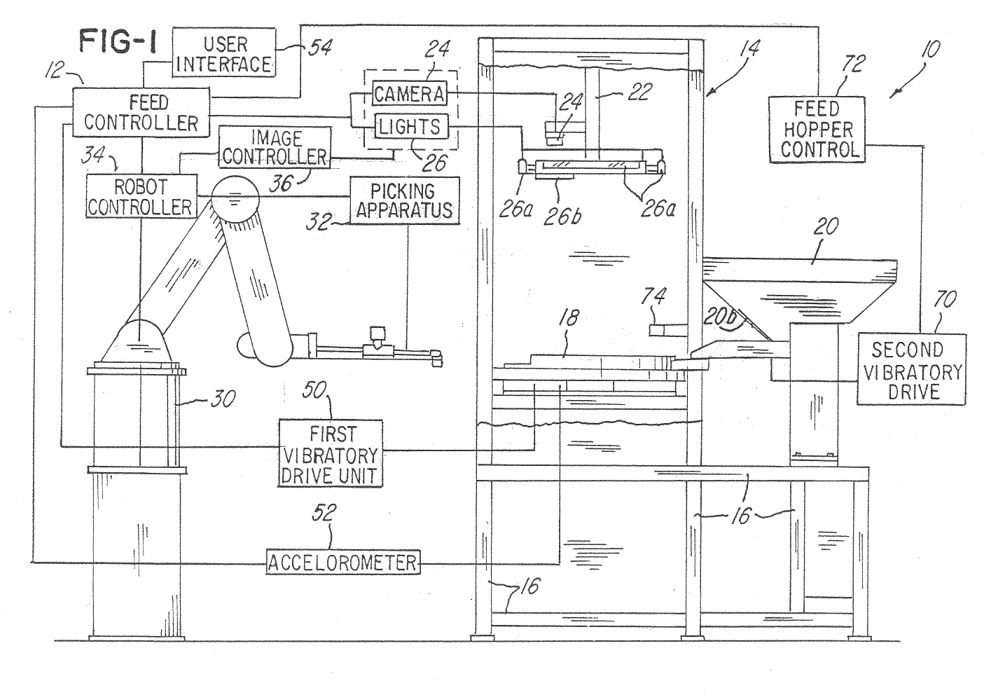

The system 10 comprises a robot 30 (FIG. 1) having a picking arm or picking apparatus 32 that is under the control of a robot controller 34 that is coupled to the feed controller 12 and to the image controller 36. Note that the feed controller 12 is also coupled to the image controller 36. Thus, it should be understood that the system 10 comprises the feed controller 12, robot controller 34 and image controller 36 which are coupled to each other to enable and allow data communication between and among them.

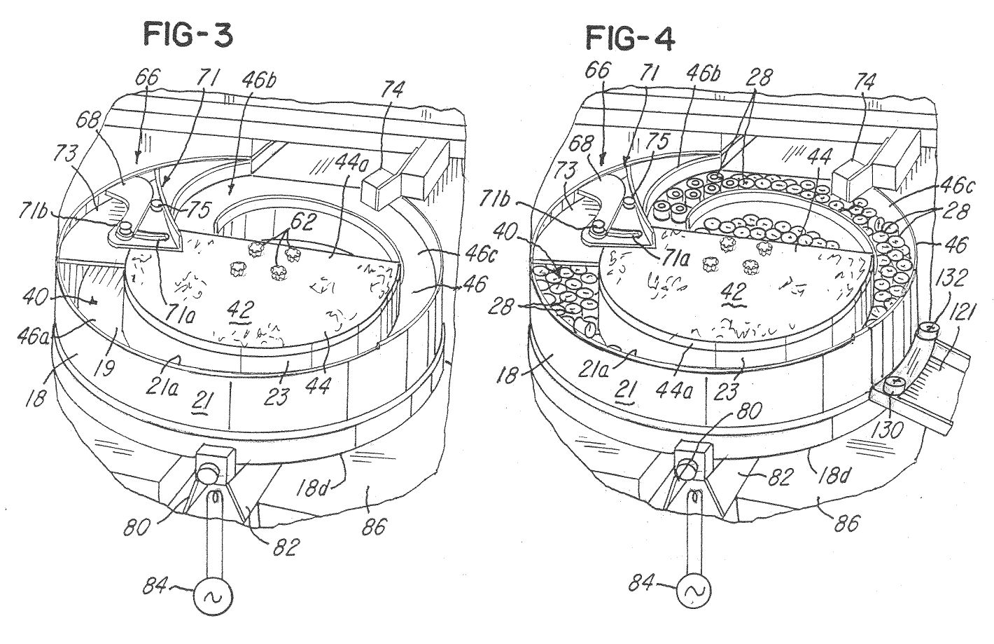

In the illustration being described, part feeder 14 (FIGS. 1 and 3-6) comprises the generally cylindrical feeding bowl 18. The feeding bowl 18 comprises a generally planar and cylindrical floor 19 (FIG. 3) that lies in a first imaginary plane and a circular wall 21 that lies in a generally circular imaginary plane. The cylindrical floor 19 and circular wall 21 cooperate to define a part receiving, storage or reservoir area 40.

The feeding bowl 18 further comprises a plate support 23 that is conventionally fastened or secured to the cylindrical floor 19 by, for example, a weld. The feeding bowl 18 further comprises a picking surface or picking plate 44 that is mounted to the plate support 23 and that defines a picking area 42. Note that the picking surface or picking plate 44 lies in a second plane that is raised above the cylindrical floor 19 a predetermined distance, such as 4-12 inches in the illustration being described, and within the cylindrical plane defined by circular wall 21. The picking area 42 is defined by a top surface 42a of the picking surface or picking plate 44 and is removably secured to the feeding bowl 18 using thumb nuts 62 (FIG. 6) described later herein.

Notice that the feeding bowl 18 comprises the receiving or storage area 40 for receiving and storing the parts 28 to be processed. The feeding bowl 18 further comprises a spiral or helically-shaped ramp 46 having an inlet 46a in communication and operative relationship with both the cylindrical floor 19 and the receiving or storage area 40 and an outlet 46b that is in communication with the picking surface or picking plate 44. Notice that the ramp inlet 46a and the ramp outlet 46b are coupled via the spiral or helically-shaped channel or track 46c as shown. The channel or track 46c is fastened or adjacent to the inner surface 21a of circular wall 21. The ramp 46 may have a supporting side wall (not shown) extending to the cylindrical floor 19 to prevent parts from becoming trapped underneath the ramp 46 during operation.

The system 10 comprises at least one recirculator, described and shown herein, that causes said parts 28 to first move from said reservoir area to said picking area and for those parts 28 that are not properly oriented or not the desired parts 28 to be picked by the robot 30 at said picking area to be recirculated from said picking area to said reservoir area. In the embodiments of FIGS. 1-18, the at least one recirculator comprises a first vibrator or vibratory drive unit 50 (FIG. 1) coupled to the feed controller 12 for vibrating the feeding bowl 18 and the parts 28 in it, the ramp 46 and the picking surface or picking plate 44. As described later herein, in the embodiment of FIG. 19, the at least one recirculator comprises a driven belt 302′ to perform automatic recirculation.

In the embodiment being described, the vibration of the feeding bowl 18 performs a dual function. It causes parts 28 to vibrate or move up the ramp 46 to the outlet 46b and also causes parts, such as parts 28b in the example, to fall, recirculate or move off of the picking surface or picking plate 44 back into the reservoir area 40. As illustrated in FIGS. 3-6, notice that the system 10 comprises a plurality of leaf springs or springs 80 and 82 conventionally coupled to the frame 16 and a bottom 18d of feeding bowl 18. The first vibratory drive unit 50 comprises an electromagnetic energizer 84 that cooperates with the springs 80 and 82 to vibrate the feeding bowl 18 in a manner conventionally known. In this regard, the springs 80 and 82 are welded to the bottom surface 18d of the feeding bowl 18 and to the frame 16 by conventional means, such as by the use of fasteners (not shown) or a weld. The electromagnetic energizer 84 energizes the springs 80 and 82 to vibrate the bowl in a manner conventionally known.

In the illustration being described, the feeding bowl 18 further comprises an accelerometer 52 (FIG. 1) that is coupled to the feed controller 12 and feeding bowl 18. The accelerometer 52 and feed controller 12 enable the user to tune the feeding bowl 18 during vibration after it has received parts 28 to find a resonant frequency of the feeding bowl 18 with the parts 28 therein in a manner that is conventionally known. The accelerometer 52 tunes the feeding bowl 18 in response to at least one of a size, shape or weight of the parts being processed or a mass of said feeding bowl 18. The system 10 comprises a user interface 54 coupled to the feed controller 12 that enables the user to adjust the amplitude at which the first vibratory drive unit 50 vibrates the feeding bowl 18 to maximize and adjust the vibration of the feeding bowl 18, ramp 46 and picking surface or picking plate 44 to cause the parts 28 to circulate, recirculate and move at a desired flow rate.

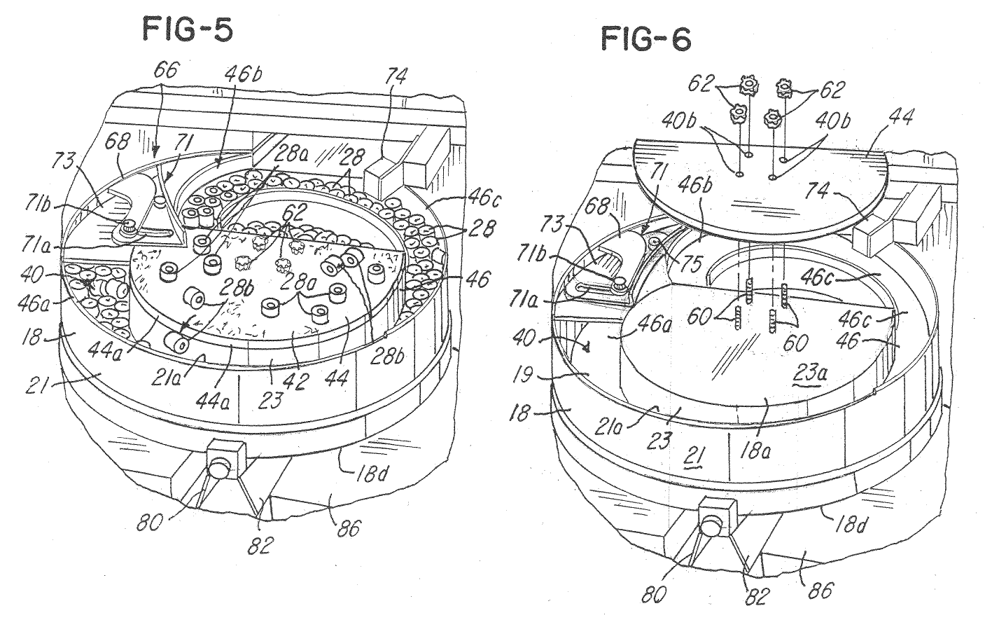

In this regard, it is a feature of this embodiment that the parts 28 flow onto the picking surface or picking plate 44 as it is being vibrated by the first vibratory drive 50 so that the parts 28 become situated at the picking area 42 where they may be picked by the picking apparatus or picking arm 32. It is important to note that the system 10 is capable of distinguishing between parts that are predetermined parts, parts that are properly oriented or parts 28 that are desired to be picked at the picking area 42 and on the picking surface 44 for picking by the picking apparatus 32 versus those parts 28 that are not predetermined parts or that are not properly oriented for picking by the picking apparatus 32 of the robot 30. For example, it is assumed for this illustration that the cylindrical parts 28 that are standing on their end, such as parts 28a in FIG. 5, are the desired or predetermined ones of the parts 28 or are the parts 28 that are properly oriented in the illustration being described for picking by the robot 30, while parts 28 that are lying on their side, such as parts 28b, are not properly oriented for picking by the picking apparatus 32 of the robot 30.

Returning to FIGS. 1 and 2, it is significant to reiterate that the vibration of the feeding bowl 18 serves multiple functions. The vibration causes parts to move up ramp 46 and onto the picking plate or picking surface 44 and also causes the parts 28b that are located in the picking surface or picking plate 44 that are not picked by robot 30 to fall over an edge 44a of the picking plate or picking surface 44 so that they can be recirculated into the reservoir area 40. Thus, it should be understood that the parts 28b that are not the predetermined or selected ones, such as parts 28b that are not properly oriented, will vibrate and move on the picking surface or picking plate 44. The robot 30 will pick the desired ones or properly oriented parts 28a when the picking surface or picking plate 44 is not vibrating. After all such parts 28a are picked by robot 30, the first vibratory drive unit 50 is energized to vibrate the feeding bowl 18 and the picking surface or picking plate 44. The vibration of the picking surface or picking plate 44 causes the undesired parts 28b to vibrate and move until they move and eventually fall over the edge 44a of the picking surface or picking plate 44 where they fall into the storage or receiving area 40 or onto the ramp 46, such as in the channel or track 46c. This feature enables the parts 28b to be recycled or recirculated back into the reservoir area 40, back up the ramp 46 and back onto the picking surface or picking plate 44.

Thus, it should be understood that the system 10 and method according to the embodiment being described permit recirculation of parts 28 utilizing the vibration which also causes the feeding of the parts 28 up the ramp 46 and to the picking surface or picking plate 44 without the need for additional parts, picking apparatus or the like. Consequently, the vibration performs not only the feeding of the parts 28, but also causes the parts 28 to be recirculated from the picking surface or picking plate 44 into the receiving or storage area 40 if they are not the properly oriented or not the desired parts 28a to be picked. This provides continuous recirculation that facilitates maximizing parts 28 feeding and increasing the number of properly oriented parts for picking by the robot 30.

Note that the parts 28a to be picked could be parts 28a that are properly oriented, but they could also be parts 28 having a predetermined characteristic, such as a predetermined size, shape, color or the like. For example, ball bearings of two different sizes may be fed, with the robot 30, for example, picking the smaller of the two, even though orientation of the bearing is not a factor in determining which bearing to pick.

In the illustration being described, the feeding bowl 18 is adapted to provide and define the receiving area or storage area 40 of predetermined or preselected size that provides a large storage capacity and automatic operation. Notice also that the part feeder 14 has no moving parts or devices, such as moving belts or lifting buckets for causing the parts 28 to move from the storage or receiving area 40 to the picking surface or picking plate 44, which minimizes or reduces the amount of moving mechanisms and parts and maintenance therefor.

Referring now to FIGS. 2 and 13, notice that the image system support 22 is operatively positioned above the feeding bowl 18 in order to capture images of the parts 28 situated at the picking area 42 and on the picking surface or picking plate 44. As mentioned herein, the image system support 22 comprises at least one of the plurality of light sources 26 for illuminating the picking surface or picking plate 44 in order to illuminate the picking area 42 to improve the image capture by the camera 24. As mentioned earlier herein, the plurality of light sources 26 may comprise the fluorescent light 26a (FIG. 2), such as light from an incandescent or fluorescent bulb. Alternatively, other light sources may be used, such as the polarized red light 26b (FIG. 13) or light that is filtered using polarizing filters. It has been found that depending that upon the parts 28 being processed, it may be desirable to use one type of light source over the other. For example, it has been found that for parts 28 that are black or dark, fluorescent red light facilitates improving the image quality of the images captured by the camera 24, while light colored parts may best be imaged by polarized red light.

To further facilitate feeding and imaging of parts 28, the picking surface or picking plate 44 may comprise a surface 44b having a preselected finish, texture or color. For example, if the parts 28 to be processed are dark in color, then a picking plate 44 having a surface 44b that is light in color may be selected to provide greater contrast in order to enable the image system support 22 to capture and process better images of the parts 28 that are situated on the surface 44b. On the other hand, if the parts 28 to be processed are light in color, then a picking surface or picking plate 44 having a relatively dark surface 44b may be selected to improve the imaging of the parts 28 when they are situated at the picking area 42.

The picking surface or picking plate 44 is also adapted to facilitate permitting the parts 28b that are not properly oriented or desired parts for picking at the picking area 42 to fall over edge 44a of the picking surface or picking plate 44 by gravity and into the storage or reservoir area 40 where they can be recirculated for feeding back to the picking surface or picking plate 44 at the picking area 42. If the parts 28 are subject to undesired rolling, such as ball bearings, then it may be desirable to use a picking surface or picking plate 44 that has a textured surface. For example, if a user is running parts 28 that are round, such as ball bearings, a brush or carpet picking surface or picking plate 44, such as a Brushlon® surface, may be used. If, on the other hand, parts 28 are being run that have solid planar surfaces, such as a cube, then a solid metallic picking surface or picking plate 44 may be desirable. The picking surface or picking plate 44 may comprise a stainless steel plate, translucent polycarbonate, Brushlon, hard anodized aluminum, foam, or textured surface. The picking surface or picking plate 44 may further comprise not only a surface that supports said parts, but a surface that is adapted to improve at least one of movement of parts on said surface or imaging of parts on said surface. The surface may further comprise a predetermined color to facilitate capturing said at least one image. For example, the picking surface or picking plate 44 may have the predetermined color that is black, silver, white or translucent to facilitate grayscale contrast.

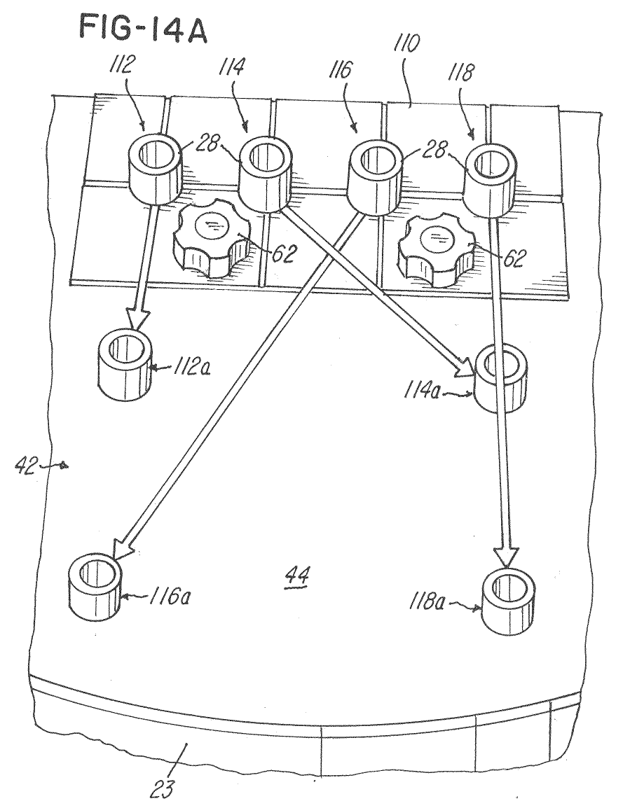

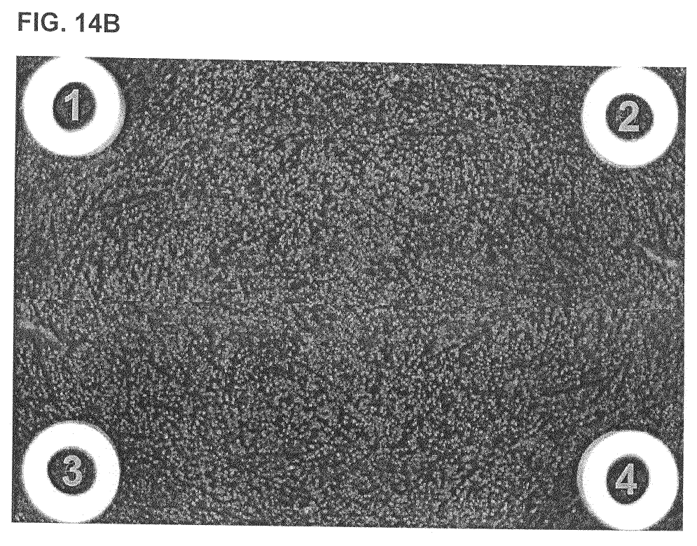

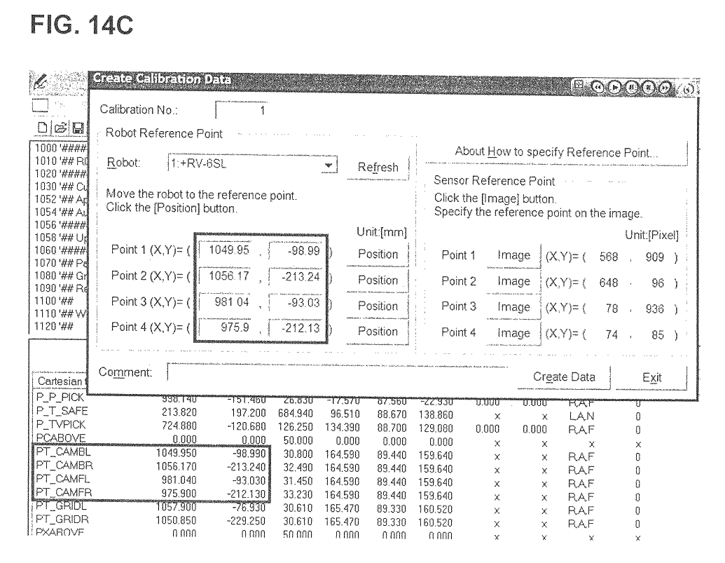

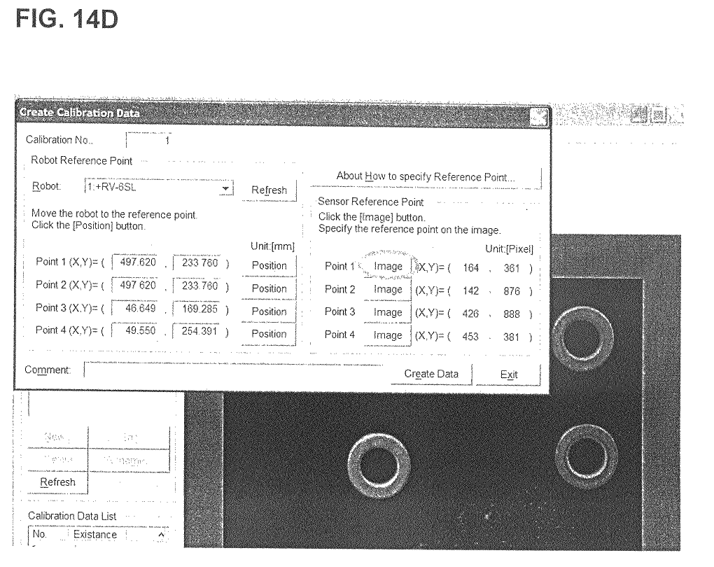

The picking surface or picking plate 44 is detachably and interchangeably mounted to the plate support 23 and above the reservoir 40. In this regard, notice in FIG. 6 that the plate support 23 mentioned earlier has a surface 23a having a plurality of threaded posts 60 integrally connected or mounted to the surface 23a by conventional means, such as a weld. A plurality of different picking surfaces or picking plates 44, such as plate 44 and an interchangeable or substitute plate 45 (FIG. 2), are provided for selection by a user. Each of the plurality of picking surfaces or picking plates 44 comprise a plurality of apertures 44c for receiving the threaded posts 60. The system 10 comprises a plurality of threaded thumb nuts 62 (FIG. 6) for detachably or removably securing the picking surface or picking plate 44 selected by the user to the surface 23a. As mentioned earlier, the picking surface or picking plate 44 is adapted and selected in response to the parts 28 to be fed or processed. Notice that the frame 16 (FIG. 2) comprises a plurality of hangers or supports 66 for supporting or storing a substitute or interchangeable plate 45 or a calibration plate (mentioned later herein relative to FIG. 14A).

Thus, one feature of the system 10 is that the interchangeable and removable picking surface or picking plate 44 and its surface texture, color and other characteristics are adapted and selected in response to the types of parts 28 and characteristics of the parts being processed. Although the picking surface or picking plate 44 in the illustration being described is generally planar, the picking surface or picking plate 44 could comprise a non-textured surface, such as is illustrated in FIG. 6, or have a non-planar surface 44b or a surface that is configured in a predetermined shape. For example, the picking surface or picking plate 44 could have a slight angular slope in cross-section away from the outlet area 46b of ramp 46 and toward the edge 44a to further facilitate causing the parts 28b that are not desired parts or parts that are not in the proper orientation to move toward and fall over the edge 44a and back into the storage or receiving area 40 for recirculation. Likewise, the picking surface or picking plate 44 is a rigid metal in the illustration, but it could be plastic, polymer or other rigid, non-rigid or flexible material.

Referring to FIGS. 3-5, notice that the part feeder 14 further comprises a part feed control 66 that is pivotally mounted to a planar member 73 which itself is conventionally mounted to the inner surface 21a, such as by a fastener or weld. In the illustration, the part feed control 66 is a moveable gate 71 that is pivotally mounted to the planar member 73 using a pivot bolt or pin 75. The gate 71 further comprises an arcuate aperture 71a that receives a bolt 71b that passes through the arm 68 and the aperture 71a to pivotally secure the gate 71 to the arm 68. When it is desired to remove or detachably mount the picking surface or picking plate 44, the nut and bolt 71b are loosened to permit the gate 71 to move to a fully open position (illustrated in FIG. 6) so that the picking surface or picking plate 44 may be detachably mounted to the feeding bowl 18 as described earlier herein. After the picking surface or picking plate 44 is detachably mounted to the feeding bowl 18, the gate 71 can be moved into operative relationship with the ramp outlet 46b to choke or pinch off the size of the ramp outlet 46b in order to control the flow and spacing of the parts as they move onto the picking surface or picking plate 44 and into the picking area 42. For example, for large parts, it may be desired to open the gate 71 fully whereas, for small parts, such as small ball bearings, it may be desirable to narrow the outlet 46b of the ramp outlet 46b to choke the number of parts 28 that move onto the picking surface or picking plate 44 at the picking area 42. Thus, the gate 71 enables choking or pinching off the feeding of the parts 28 to the picking surface or picking plate 44 so that separation between and among the parts 28 being fed to the picking area 42 can be controlled. It has been found that by having greater part separation, it is easier for the image system 24 to capture images of the picking surface or picking plate 44 and therefore the parts 28 thereon.

Referring back to FIGS. 1 and 2, notice that the system 10 further comprises the feed hopper 20 having a manually slideable feed hopper door 20b that is can be manually opened and closed (block 25 in FIG. 1) to permit parts to flow out of the feed hopper at a desired rate. The system 10 further comprises a second vibratory drive 70 that vibrates the feed hopper 20 to cause parts to move from a feed hopper storage area 20a past the feed hopper door 20b after the feed hopper door 20b has been actuated to the open position. In this regard, it should be understood that the feed hopper control 72 energizes the second vibratory drive 70 to vibrate the feed hopper 20 in a manner conventionally known so that parts 28 may flow from the feed hopper storage area 20a and onto the ramp or track 46c as illustrated.

The system 10 further comprises a sensor 74 that is mounted to the frame 16 in operative relationship with the ramp track 46c in order to sense whether parts 28 are moving up the ramp 46 toward the outlet area 46b. The sensor 74 is coupled to the feed controller 12 and if the sensor 74 senses either no parts are present or moving in the track 46c or less than a desired number of parts 28 are present or moving in the track 46c, then the feed controller 12 will energize or signal the feed hopper control 72, which in turn energizes the second vibratory drive 70 to and cause the feed hopper 20 to feed parts past the feed hopper door 20b and into the channel or track 46c downstream of the sensor 74 until the desired number of parts are replenished in the feeding bowl 18 and the sensor 74 senses an adequate number of parts 28 in the ramp 46.

During operation, when the feeding bowl 18 is empty, a user fills the feeding bowl 18 with a desired number of parts to be fed or processed. The user may fill the feeding bowl 18 manually or use the user interface 54 to cause the feed controller 12 to energize the first and second vibratory drives 50 and 70 and the feed hopper control 72 which energizes the second vibratory drive 70 to vibrate the feed hopper 20 so parts 28 move onto the ramp 46. The feed controller 12 cooperates with the sensor 74 to sense when a desired number of feed parts 28 are situated and located on the ramp 46 whereupon it ceases energizing the feed hopper control 72. The feed controller 12 continues energizing the first vibratory drive unit 50 until a predetermined number of properly oriented parts are situated on the picking surface or picking plate 44 at the picking area 42. The determination of when the picking surface or picking plate 44 has adequate parts for picking at the picking area 42 will now be described.

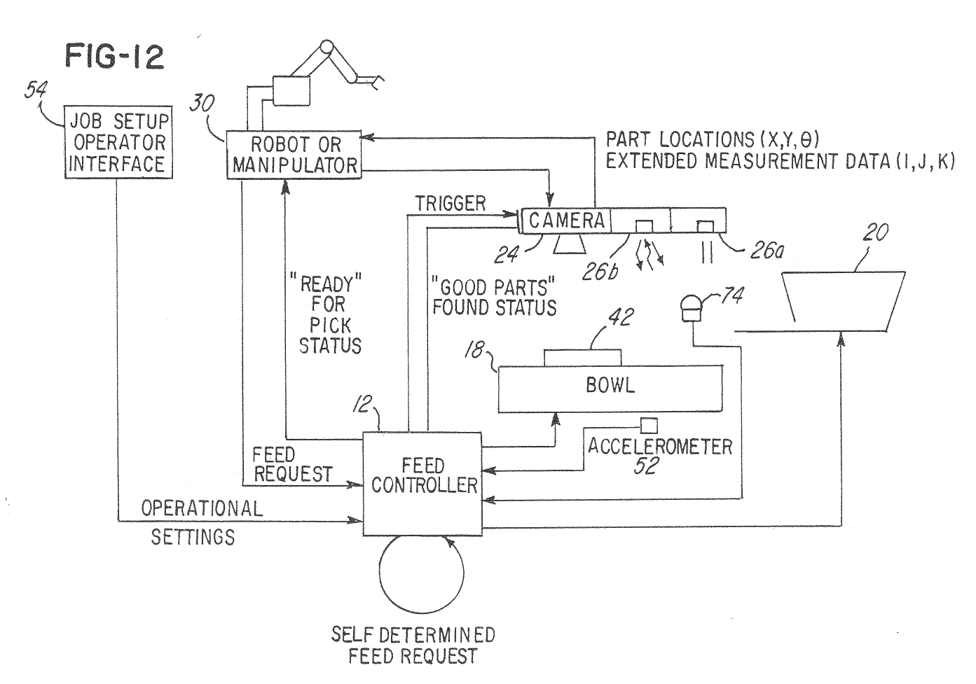

The image controller 36 is coupled to the robot controller 34 so that the robot controller 34 can cause the image system 24 to capture images of the parts 28 and generate image data with respect thereto. The image system 24 and the image controller 36 are also coupled to the feed controller 12 and are integrated for taking pictures of the parts 28 and reporting back from the image system 24 and to the robot 30 that the parts 28 are in sight or located on the picking surface or plate 44 described later herein. Also, the robot controller 34 and the feed controller 12 are coupled together for management of readiness for causing the feed hopper control 72 to energize the second vibratory drive 70 to cause more parts to be fed into the feeding bowl 18. Notice that because each of the feed controllers 12, 34 and 36 share access to each other, an ability to parallel process and have one to one interaction when required is possible between the components. This provides a more efficient robot motion and feed cycle time. FIG. 12, which will be described later herein, illustrates a schematic of data sharing occurring in one illustrative embodiment of the invention.

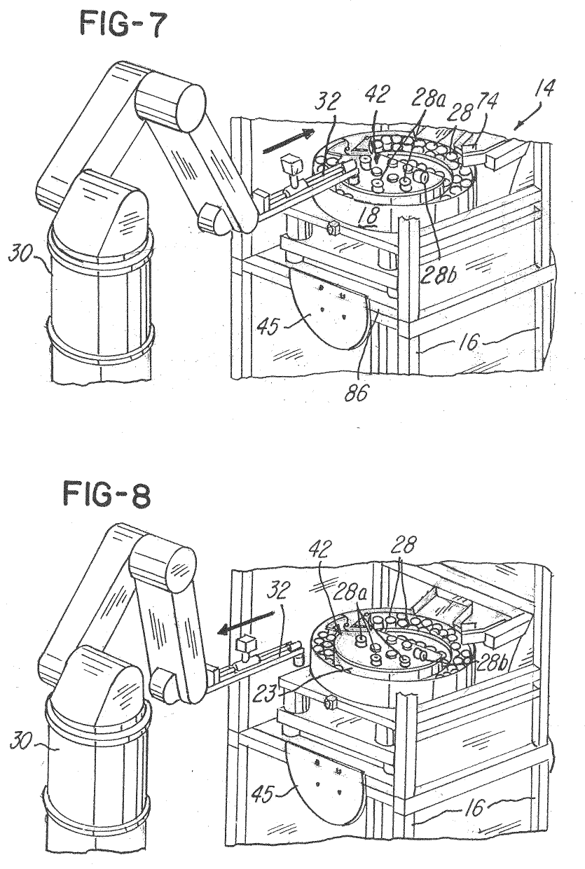

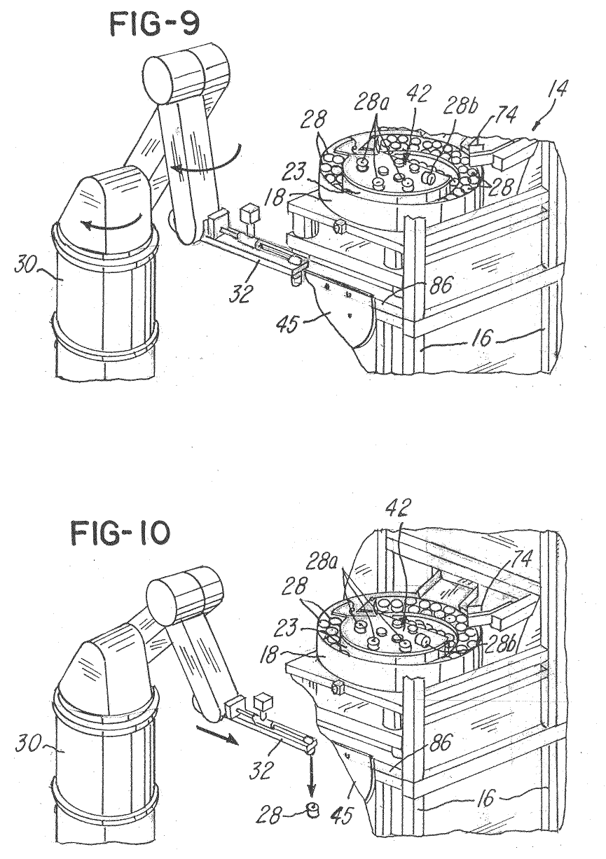

In general and during one illustrative mode of operation, feed controller 12 sends an image request to image controller 36 which causes the image system support 22 to actuate the plurality of light sources 26 and camera 24 to capture an image of the picking area 42. The image controller 36 generates the image data in response to the captured image(s). The feed controller 12 receives and processes the image data to determine if at least one properly oriented part or desired part to be picked, such as part 28a in the illustration, is located at the picking area 42. If it is, the feed controller 12 signals the robot controller 34 which energizes the robot 30 (FIGS. 7 and 8) and the picking apparatus 32 to pick the desired part 28a and to transfer it from the picking area 42 to a downstream or drop off area (FIGS. 9 and 10) where the picked part 28a may be further processed. In a manner that is conventionally known, the feed controller 12 passes the coordinates of the properly located part on the picking surface 44b to the robot 30 so that the picking apparatus 32 can accurately and quickly pick the properly oriented or desired part 28a.

It should be understood that the picking apparatus 32 of the robot 30 does not pick parts 28 in the embodiment being described during vibration of the feeding bowl 18. It has been found that providing a settling time for the vibration and movement of parts 28 to settle at the picking area 42 improves image quality. For example, heavy round parts require slightly more time to settle than lightweight non-round parts. Consequently, the image system support 22 delays triggering the camera 24 and plurality of light sources 26 a predetermined amount of settle time in order to allow the parts 28 more time to settle.

During the initial start up and prior to picking any parts, the feed controller 12 initiates an auto tune mode during which the accelerometer 52 determines the resonant frequency of the feeding bowl 18 after it is filled with the parts 28 to be processed or fed. The natural frequency of the feeding bowl 18 will change depending on the part, part size, part weight and the like. By detecting the natural frequency of the feeding bowl 18, a wider variety of parts 28 can be processed since the feeding bowl 18 can be self optimized. The feed controller 12 comprises a bowl vibration amplitude control that can be accessed by the user through the user interface 54 so that the user can control the amplitude of the frequency of the feeding bowl 18 so that the user can select and optimize the feed rate at which the parts 28 are being fed from the storage or receiving area 40 through the ramp 46 to the picking surface or picking plate 44.

After the resonant frequency of the feeding bowl 18 and the amplitude is selected by the user, the feed controller 12 will energize the first vibratory drive unit 50 to vibrate parts until an adequate or predetermined number of properly oriented parts or desired parts, such as parts 28a (FIG. 5) in the illustration being described, are situated on the picking surface or picking plate 44 at the picking area 42. As mentioned earlier, the feed controller 12 causes the image system support 22 to capture an image of the parts 28 situated at the picking area 42 at predetermined intervals and in the manner described herein. After feed controller 12 or robot controller 34 determines that a predetermined number of properly oriented parts 28a are situated on the picking surface or picking plate 44 at the picking area 42, the feed controller 12 ceases energizing the first vibratory drive unit 50 and the vibration of the feeding bowl 18 ceases. Thereafter, the robot 30 may be energized by either the feed controller 12 or by its own robot controller 34 to begin picking the properly oriented parts, such as the parts 28a in the illustration being described, from the picking surface or picking plate 44. As mentioned, the picking apparatus 32 (FIGS. 7-10) picks the desired or properly oriented parts 28a and moves them to a desired location (not shown) where they can be further fed or processed. In the illustration being described, the picking apparatus 32 is a vacuum picker, but the picking arm or picking apparatus 32 could be any conventional picking apparatus, such as an electromagnet, permanent magnet, vacuum, robotic fingers or grabbers and the like.

Thus, it should be understood that during one illustrative mode of operation, the image system support 22 captures images at predetermined intervals. At some point when parts 28 in the feeding bowl 18 become depleted, the image system support 22 with the feed controller 12 will receive image data from the image controller 36 of the image system support 22 and determine that there are less than a predetermined number of properly oriented or desired parts 28a situated on the picking surface or picking plate 44 at the picking area 42. When this occurs, the feed controller 12 will energize the first vibratory drive unit 50 to vibrate the feeding bowl 18 and cause more parts to vibrate up the ramp 46 and onto the picking surface or picking plate 44, thereby replenishing the picking area 42 with properly oriented or desired parts.

As mentioned earlier, if the feed controller 12 detects, via sensor 74, that an inadequate number or less than a predetermined number of parts 28 are situated on the ramp 46 or in the storage area 40, then feed controller 12 will energize the feeder bowl control 72 to energize the second vibratory drive 70 and the feed hopper control 72 to energize the second vibratory drive 70, which in turn causes parts to be fed from the feed hopper storage area 20a into the ramp 46 until a predetermined number of parts are situated on the ramp and in the feeding bowl 18.

In this illustration, the feed controller 12 causes the feed hopper control 72 to energize the second vibratory drive 70 only when the first vibratory drive unit 50 is vibrating the feeding bowl 18, which ensures that the parts 28 being fed into the ramp 46 are moving along and upward toward the ramp outlet 46b. In one embodiment, the “on” time for the second vibratory drive 70 associated with the feed hopper 20 is for a period of N seconds and occurs while the feeding bowl 18 is being vibrated by the first vibratory drive 50. If the sensor 74 detects a low level of parts 28 in the feeding bowl 18, then the feed controller 12 and feeder bowl control 72 cooperate to provide more parts 28 into the feeding bowl 18. The number of seconds or time period during which the second vibratory drive 70 vibrates the feed hopper 20 is less than N or less than the number of seconds or time period that the first vibratory drive 50 energizes the feeding bowl 18.

During the initial set up, the user may also adjust the position of the adjustable gate 71 in order to control the flow, spacing and/or separation of the parts 28 onto the picking surface or picking plate 44.

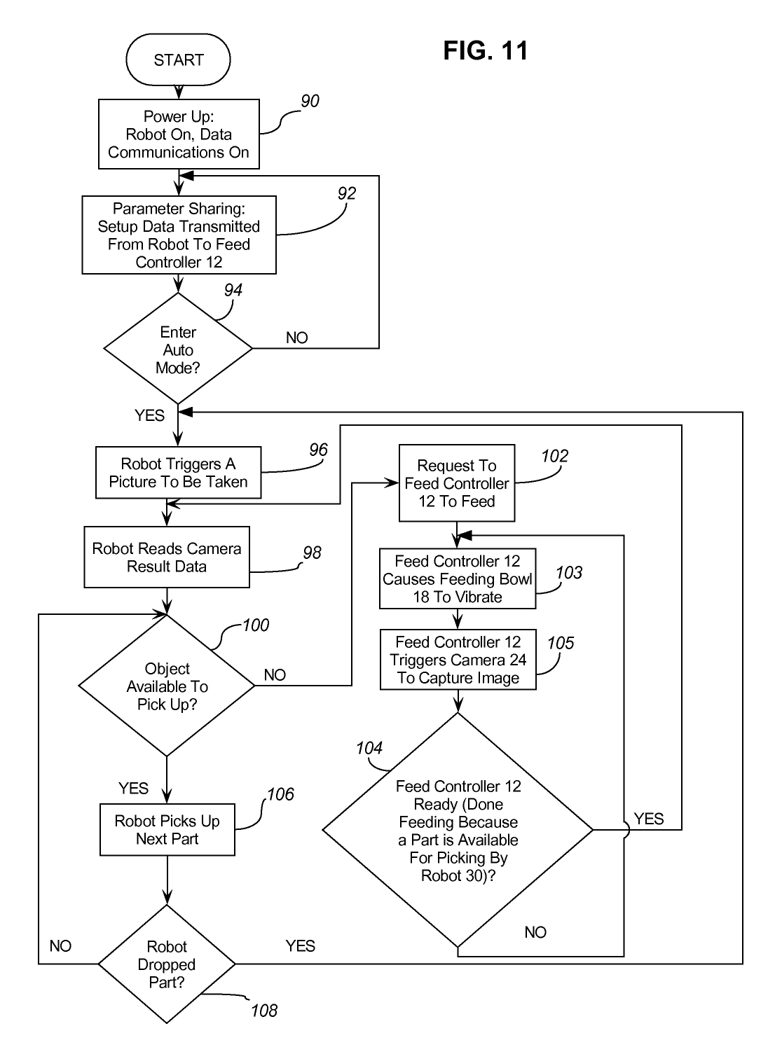

The system 10 further comprises an automatic mode of operation which will now be described relative to FIG. 11. The operation begins at block 90 whereupon the user powers up the system 10 including the feed controllers 12, image controller 36, feeder bowl control 72, robot controller 34 using the user interface 54. At block 92, the robot controller 34 communicates with the feed controller 12 in a manner conventionally known, the set up data that is transmitted between the robot controller 34 to the feed controller 12. The data that is shared is conventionally known and some of which is shown in FIG. 12 attached hereto. FIG. 12 shows a schematic view of some of the typical data sharing among various components in the system 10.

Next, at decision block 94, it is determined whether the user has selected the auto mode of operation. If he has not, the routine loops back to block 92. If he has, then the robot controller 34 of the robot 30, instead of the feed controller 12, energizes the image controller 36 (block 96) to energize the camera 24 and plurality of light sources 26 to capture an image of the picking area 42 and the picking surface or picking plate 44. In the embodiment illustrated, the image data is first read by the robot controller 34, and after that, the feed controller 12 auto feeds parts 28 until there are some ready for picking off of the picking surface or picking plate 44.

The routine continues to block 98 where the robot controller 34 reads the image data received from the image controller 36 and the robot controller 34 determines at decision block 100 whether there is an object or part 28 that is in a properly oriented position or is a proper part 28 for picking from the picking area 42. If there is not, the routine continues to block 102 wherein the robot controller 34 requests feed controller 12 to begin feeding parts up the ramp 46 and to the picking area 42 in the manner described herein. Thereafter, the routine continues to decision block 104 wherein properly oriented or predetermined ones of the parts 28, such as the parts 28a in the illustration, are available for picking. If they are not, then feed controller 12 continues energizing the first vibratory drive unit 50 causing vibration to cause more parts 28 to be fed to the picking area 42. If they are, then the routine continues back to block 98, as shown.

If the decision at decision block 100 is affirmative, then the robot 30 in picking apparatus 32 picks the properly oriented or desired part, such as part 28a in the example, at block 106. Although not previously mentioned, it should be understood that the parts 28 are not manually moved or manipulated to the properly oriented position, but randomly assume this position as they are received in the ramp inlet 46a or as they move up the ramp 46, through the outlet 46b and into the picking area 42.

At decision block 108, it is determined whether the picking apparatus 32 of robot 30 has dropped the picked part 28a, and if it has, then the routine loops back to block 96 as shown where another image is captured of the picking area 42 to determine if there are any predetermined parts or properly oriented parts available for picking from the picking surface or picking plate 44. The routine proceeds to block 98.

If the decision at decision block 108 is negative, then the robot 30 has not dropped the part 28a and the part 28a is then transferred by the picking apparatus 32 and the robot 30 to a subsequent processing or feeding station (not shown) and thereafter the routine loops back to decision block 100 as shown.

Thus, it should be understood that the system 10 can enter the automatic mode with the robot controller 34 causing the image system support 22 to capture images of parts 28 at the picking area 42 and generate a part feed request from the robot 30. The feed request causes the feed controller 12 to energize the first vibratory drive 50 and vibrate the feeding bowl 18 to cause parts 28 to move up along the ramp 46 and onto the picking surface or picking plate 44. If necessary, the feed controller 12 causes the feed hopper 20 provide the parts 28 from the feed hopper 20 to the ramp 46 in the manner described earlier.

After a brief settling time, the system 10 takes another image of the picking surface or picking plate 44 and processes the image and provides the image data to the robot controller 34. In the event the robot controller 34 needs additional camera or image data, it can request a re-feed of the image data that was previously transmitted or cause the image system support 22 to capture another image of the picking area 42.

Once the automatic mode of operation is entered, the feed controller 12 will wait for a feeding signal and wait to feed parts in response to robot controller 34. The feed controller 12 will generate and output a “ready” signal to tell the robot controller 34 of robot 30 to begin using the image data from the image system support 22 to locate and pick up the properly oriented or predetermined ones of the parts 28. When the system 10 is not in auto mode, feed controller 12 will await data and signals from robot controller 34. As mentioned earlier, FIG. 12 shows a schematic view of some of the typical data sharing among various components in the system 10.

The automatic mode of operation may be configured with a variety of system adjustment parameters that control the basic modes of operation and timing of the feeder 14. These parameters are mentioned later herein.

Referring now to FIG. 12, a simplified schematic of the data sharing in one embodiment of the illustration being described is shown. Notice that the feed controller 12 receives operational settings from the user interface 54. The feed controller 12 receives the feed request from the robot 30 and triggers the image system support 22 and energizes the camera 24 and plurality of light sources 26 to capture the image of the picking area 42 as shown and as described earlier. If the predetermined number or quantity of parts 28 is not in the feeding bowl 18 or on the ramp 46, then the feed controller 12 energizes the feeder bowl control 72 to energize the second vibratory drive 70 which vibrates the feed hopper 20 to cause parts 28 to flow into the feeding bowl 18 as described earlier herein. After the level sensor 74 senses that an adequate level of parts 28 are in the ramp 46, the feed controller 12 ceases energizing the feeding bowl control 72, which in turn ceases energizing the second vibratory drive 70. During this time the feed controller 12 has energized the first vibratory drive unit 50 which causes vibration of the feeding bowl 18 and ramp 46 in the manner described earlier.

Regardless of whether the feed controller 12 generates a self determination feed request or receives a feed request from the robot 30, the system 10 will cease energizing both the first vibratory drive unit 50 and the second vibratory drive unit 70 when an adequate or predetermined number of properly oriented or desired parts are located at the picking area 42.

The system 10 further comprises a calibration system and method for calibrating the camera 24 to the robot 30 and picking apparatus 32. In the illustration being described, the robot 30 is a Melfa® model robot available from the assignee hereof, Rixan Associates, Inc. of Dayton, Ohio. As is conventionally known, such Melfa® model robots comprise a MelfaVision® program (not shown) also available from Mitsubishi Electric Automation, Inc. of Vernon Hills, Ill. and Dayton, Ohio for calibrating the robot 30 and for allowing any camera that is coupled to the robot to communicate to the robot 30 the robot's coordinates. This calibration process is simplified using a calibration helper picking plate 110 (FIG. 14A), which can be detachably mounted to the feeding bowl 18 in place of the picking surface or picking plate 44 using the thumb nuts 62. In the illustration being described, four parts 28 are located in a predetermined position at four spots or positions 112, 114, 116 and 118, as illustrated in FIG. 14A. The four parts 28 are picked up by the picking apparatus 32 of the robot 30 and placed into four known positions 112a, 114a, 116a and 118a, respectfully on the picking plate 110 and the camera's 24 field of view, as illustrated in FIG. 14B. Next, the image data associated with the images captured by the camera 24 are correlated with the position on the picking plate 110.

The system 10 comprises the user interface 54 and also includes an optional degrees-of-freedom operator interface (not shown) that is displayed on the user interface 54. Such interface is commercially available from Rixan Associates, Inc. of Dayton, Ohio, the assignee of the present application. In this interface, the system 10 will display on the user interface 54, the coordinates to type into a calibration grid (FIG. 14C) in the MelfaVision® program provided with the robot 30. The parts 28 are placed in the arrangement illustrated in FIG. 14A and moved by the robot 30 to the four known positions, 112a-118a. Using the alignment program and calibration plate 110, the points associated with each of the parts represent four corners of the field of view (FIG. 14B) for the camera 24. The X-Y coordinates of these points are entered by the user directly into the conventional MelfaVision® calibration page. The user then drives each of four cross-hairs (not shown) or locaters in the interface (not shown) over each of the four parts 28. At this point, the picking apparatus 32 is calibrated relative to the camera 24. As mentioned earlier, the Degrees of Freedom user interface 54 is optional.

Thus, it should be understood that the calibration plate 110 provides initial positions for a plurality of the calibration parts 28. The calibration parts are picked by the robot 30 and placed into the four known positions 112a-118a. Note that parts 116 and 118 have been moved closer to the edge 44a of the picking surface or picking plate 44. The overhead camera 24 captures the picture of the relocated parts 112-118 as illustrated in FIG. 14B. Again, these positions represent the four corners of a field of view of the camera 124.

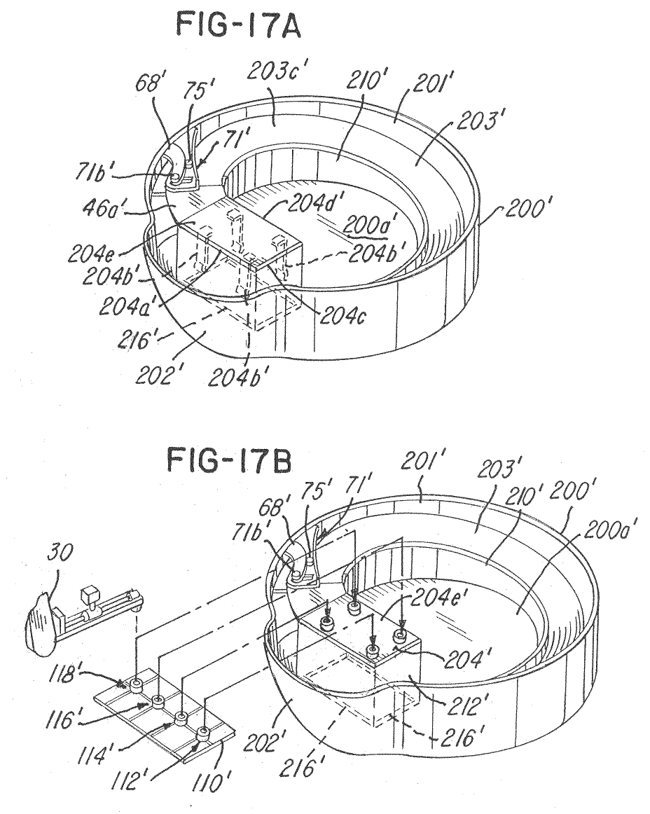

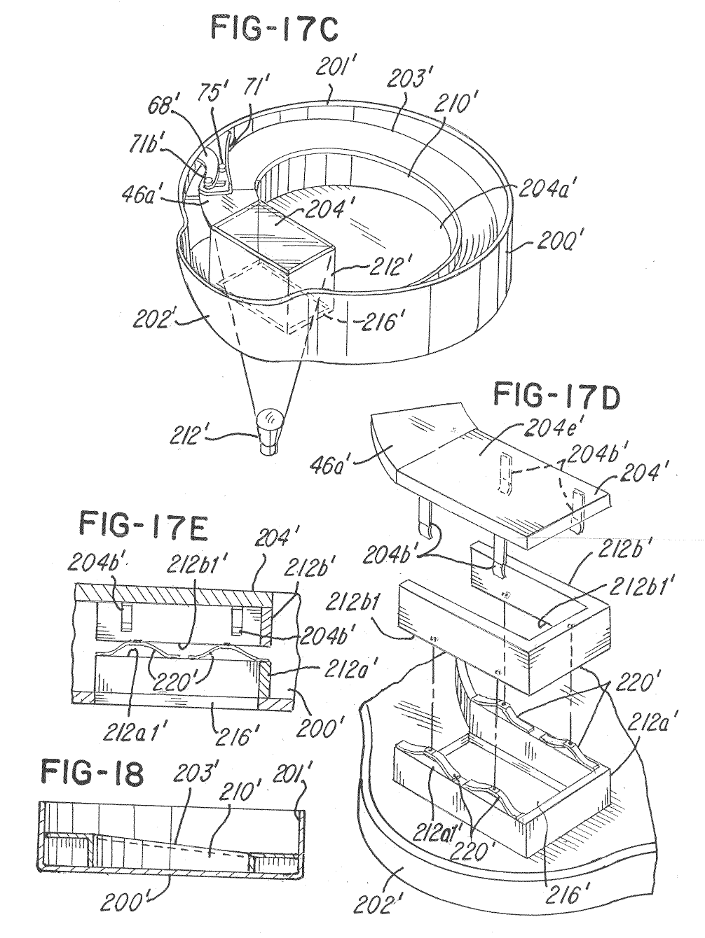

In an alternate embodiment shown and described later herein relative to FIG. 17B, the calibration plate 110 may be remote from the feeding bowl 18, fixed to it or even adjacent to it as illustrated in the embodiment shown. Advantageously, the system and method provides means and apparatus for staging within the boundaries of the feeding bowl 18 or remotely to enable the robot 30, and the calibration plate 110 provides known and programmed spots or positions for the robot 30 to place the parts, thereby facilitating calibrating the robot 30 with respect to the picking surface or picking plate 44 to enable the robot to accurately pick desired parts 28a of said parts 28.

In a manner conventionally known, a graphical user interface, such as the interface shown in FIG. 14C, specifies or identifies the positions of the parts 112-118 relabeled 1, 2, 3 and 4, respectively in the illustrative interface in FIG. 14C. Notice that when the robot 30 and the picking apparatus 32 move the parts 112-118 to the locations illustrated in FIGS. 14A and 14B, the reference points for those parts were automatically determined using a standard alignment program available from Rixan Associates, Inc. of Dayton, Ohio. Once the points are determined, they can be calibrated with the image data (illustrated to the right of the screen shot in FIG. 14C) and the reference points can be entered directly into the robot 30's calibration control program, which in the illustration being described is the MelfaVision® program available from Rixan Associates, Inc. of Dayton, Ohio.

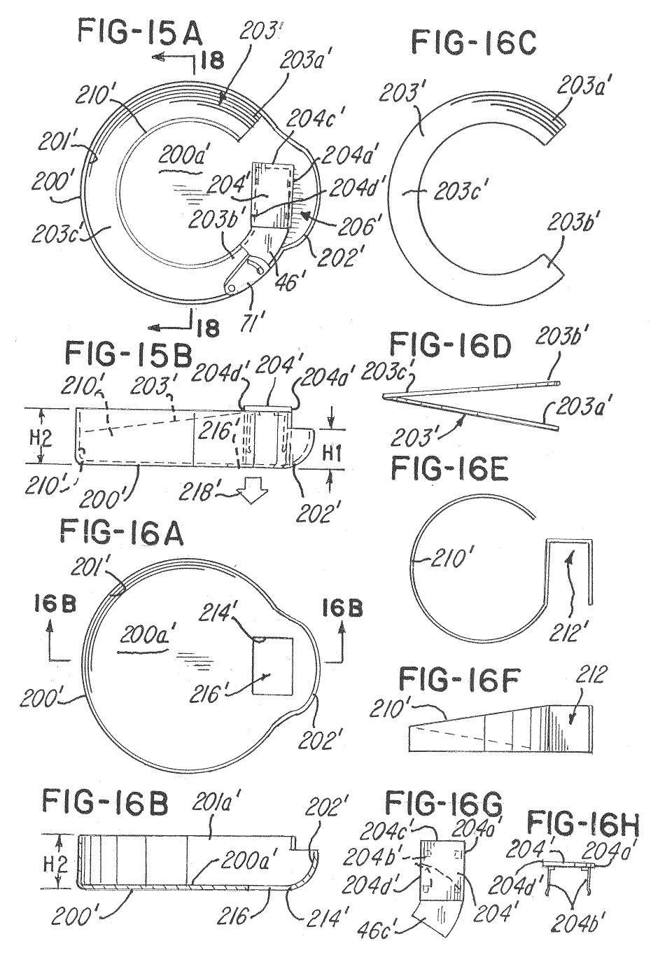

Referring now to FIGS. 15A-19, other embodiments of a bowl and system are shown. It should be understood that like parts 28′ are identified with the same part numbers except that a prime (“′”) has been added to the part numbers of FIGS. 15A-18. The feeding bowl 18 in the illustrative embodiment is replaced with a different bowl in the embodiments of FIGS. 15A-19. For example, the embodiment of FIGS. 15A-18 comprises the bowl 200′ comprising a plurality of different features that will now be described. It should be understood that the other components of the system 10, such as the vibratory drive unit 50, the various controllers, image system, hopper and the like and various other components of FIG. 1 remain the same, but they are not shown in FIGS. 15-19 for ease of description and illustration.

As illustrated in FIGS. 15A-18, this embodiment comprises the bowl 200′ having a wall 201′ and a track or ramp 203′ having an inlet 203a′, an outlet 203b′ and a track or ramp 203c′ which connects the inlet 203a′ to the outlet 203b′ as shown.

The bowl 200′ further comprises an interior wall 210′ that supports the ramp 203′ and a picking surface or picking plate 204′. In this embodiment, note that the wall 201′ that is not entirely circular and has a portion 202′ that extends or bulges away from the picking surface or picking plate 204′ as shown. As illustrated, the bulge or portion 202′ (FIG. 15B) has a dimension or height H1 that is shorter or smaller than the height H2 of wall 201′. Notice also that a portion of the wall 210′ is curved or arcuate to facilitate an operator manually removing parts 28′ from the bulge 202′. The bulge or portion 202′ facilitates opening the area 206′ adjacent an edge 204a′ (FIG. 15B) of the picking surface or picking plate 204′ as shown.

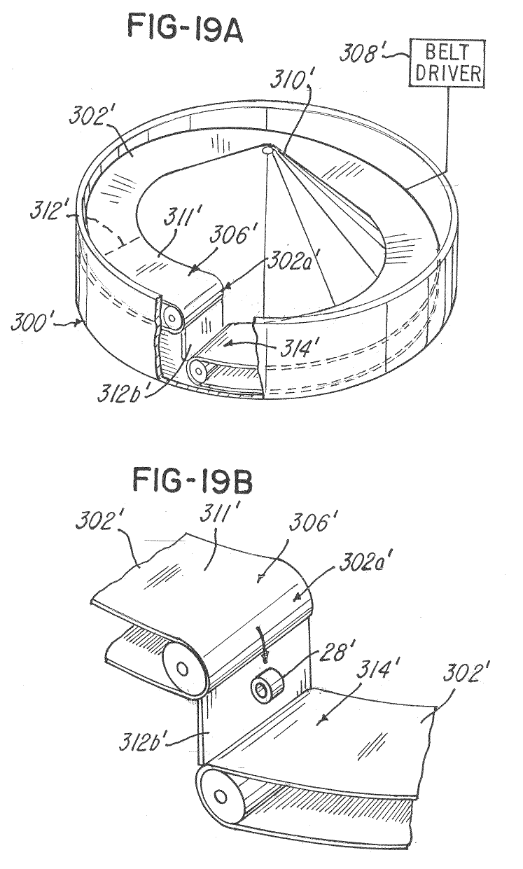

In this illustration, the interior wall 210′ is configured as illustrated in FIGS. 16E and 16F. The interior wall 210′ is conventionally secured to the ramp 203′, which in the illustration which is generally helical or spiral upward (FIG. 16D) from ramp inlet 203a′ to ramp outlet 203b′ of approximately 270 degrees (FIG. 16C) as opposed to the ramp 46 in the embodiment described earlier herein which is approximately 360 degrees. In this illustration, the interior wall 210′ cooperates with the outer wall 201′ to support the ramp 203′ and the removable picking surface or picking plate 204′ as shown. In the illustration being described, the ramp 203′ may be welded to the outer wall 201′ and interior wall 210′ in a manner conventionally known. Note that interior wall 210′ seals off the area underneath the ramp 203′ so parts 28′ cannot get trapped or jammed underneath the ramp 203′. FIG. 18 illustrates a cross-sectional view of the bowl 200′ and the walls 201′ and 210′ that prevent the parts 28′ from becoming jammed or trapped underneath the ramp 203′.

In this embodiment, the bowl 200′ comprises the picking surface or picking plate 204′ that comprises a plurality of resilient clips 204b′ (FIGS. 16G and 16H) for removably securing picking surface or picking plate 204′ from the interior wall 210′. In this regard, notice that the wall comprises a generally U-shaped portion for supporting the picking surface or picking plate 204′ above a surface 200a′ of the bowl 200′. In the illustration being described and as shown in FIGS. 15A and 17A, note that the picking surface or picking plate 204′, comprises edges 204a′, 204c′, 204d′ that are open or interrupted to permit parts 28′ to fall from the picking surface or picking plate 204′ and into the bowl 200′. In this illustration, unlike the illustration of FIGS. 1-3, there are no thumb nuts 62 to attach the picking surface or picking plate 204′ to the bowl 200′ and the picking surface or picking plate 204′ is uninterrupted. One advantage of the illustration being shown in FIGS. 15A-17C is that different types of picking surfaces or picking plates 204′ may be selected and used. For example, the plate 204′ may be stainless steel, polymer, translucent polycarbonate, Brushlon, hard anodized aluminum, opaque, non-opaque, foam or even textured.

Moreover, even a transparent or non-opaque picking surface or picking plate 204′ may be used with a second light source 212′ coupled to controller 12 for illuminating the picking surface or picking plate 204′ from underneath the bowl 200′ as illustrated in FIG. 17C. In this regard, notice that the bowl 200′ comprises a bottom surface 200a′ having an interior edge or wall 214′ that defines an aperture 216′ that performs multiple functions that will now be described.

In a first function of the aperture 216′ is to permit light rays from the underneath light source 212′ to shine through the aperture 216′ in order to illuminate the picking surface or picking plate 204′ to facilitate image capture.

Another function of the aperture 216′ is that it can be used for part 28′ removal when the picking surface or picking plate 204′ has been removed from the bowl 200′. In this regard, when it is desired to remove parts 28′ from the bowl 200′, the operator or user simply removes the picking surface or picking plate 204′ from the U-shaped portion 202′ which permits parts 28′ to travel up the ramp 203′ and through the outlet 203b′ and into the aperture 216′ (FIGS. 15A and 15B) where the parts 28′ fall through the bottom surface 200a′ and into, for example, a container (not shown) such as a bucket. Thus, in this embodiment, the bowl 200′ comprises means and apparatus for easily removing parts 28′ from the bowl 200′ and for illuminating the picking surface or picking plate 204′ from below or underneath the picking surface or picking plate 204′.

In this embodiment, the calibration plate 110′ in the illustration being described can be adjacent to or remote from an interior of the feeding bowl 200′ as illustrated in FIG. 17B. The calibration of the system 10 with the embodiment of FIGS. 15A-17B would be similar to that described earlier herein relative to FIGS. 1-14D, except the calibration plate 110′ is remote from the picking surface or picking plate 204′.

Advantageously, the field of view of the camera 24′ may be selected or adjusted so it is the same or substantially the same as the area of the top surface 204e′ (FIG. 17A) of the picking surface or picking plate 204′.

In the illustration described earlier herein relative to FIGS. 1-14D, the picking surface or picking plate 42 was compressible in the vertical direction because the picking surface or picking plate 42 had a compressible textured surface. In the illustration of the embodiment shown in FIGS. 15A-17C, it may be desired to use a picking surface or picking plate 204′ that is not compressible in the vertical direction. In order to permit the picking surface or picking plate 204′ to move in a vertical direction as viewed in FIGS. 17D-17E, yet be non-compressible, the U-shaped portion 202′ may be segmented into portions 212a′ and 212b′ and a plurality of leaf springs 220′ inserted and fastened therebetween, as illustrated in FIG. 17E, to permit the picking surface or picking plate 204′ to move vertically. In this regard, the leaf springs 220′ are screwed or welded to the surfaces 212a1′ and 212b1′ in a manner that is conventionally known. Advantageously, this permits the user to use a picking surface or picking plate 204′ that is non-compressible, flat and/or provides hard surface 204e′, while permitting the plate 204′ to move in a vertical direction (as viewed in FIG. 17E).

Advantageously, the embodiment of FIGS. 15A-17E provide an alternate embodiment and means for using a transparent or non-opaque picking surface or picking plate 204′ and providing another illustration of a continuous recirculation bowl 200′ that provides continuous recirculation of parts 28′ for picking by the robot 30′ in a manner described earlier herein.

FIG. 19 illustrates still another embodiment of the automatic recirculation feature. In the embodiments illustrated in FIGS. 1-17E, movement of the parts 28 was provided by a single source, namely the vibration of the feeding bowl 18 caused by one or more vibratory drives 50. In the illustrations of FIGS. 1-14D, the feeding bowl 18 and ramp 46 were vibrated so that parts 28 would travel up the ramp 46 and to the picking area defined by the picking surface or picking plate 44 and 42. The illustration of FIGS. 15A-17E operates similarly. In the illustration being shown in FIG. 19, another illustrative means for continuous recirculation is provided. In this illustration, a bowl 300′ comprises an endless belt 302′ which is inclined and carries parts to a picking area 311, which is defined by an area 306′ between the end 302a′ of the belt 302′ and the line 312′, which generally corresponds to a field of view of the camera 24′.

The belt 302′ is driven by a belt driver 308′ that is coupled to the feed controller 12. The feed controller 12 energizes and operates the belt driver 308′ in substantially the same manner as feed controller 12 energizes and operates the first vibratory drive unit 50 described earlier herein relative to FIG. 1.

Note that the bowl 300′ comprises a frusto-conical or raised central portion 310′ which causes parts 28′ in the bowl 300′ to be continuously urged toward and onto the belt 302′.

Parts 28′ are carried by the belt 302′ until they reach the area 306′. The parts 28′ in the area 306′ that are properly oriented are picked by robot 30. When there are no properly-oriented parts 28′ for picking by robot 30, feed controller 12 energizes belt driver 308′ to drive the belt 302′. This causes unpicked parts to fall onto the belt 302′ at the area 314′ (FIG. 19B). A wall 312b′ (FIG. 19B) prevents parts 28′ from falling underneath the belt 302′ and becoming trapped underneath the belt 302′.

Thus, advantageously, it should be understood that the system and method of the embodiments described herein provide for automatic and continuous recirculation of parts for picking by the robot 30. The recirculation is driven by one or more sources, such as vibration, belts or other means. An important feature of the invention, regardless of the manner in which parts 28′ are driven within the bowl 300′ is that the system 10 and method provide means for automatic recirculating parts 28′ from an area where the robot 30 picks parts 28′ and back into an area where the parts 28′ can be recirculated and moved to the picking surface or picking plate 204′, which in the illustration being described relative to FIG. 19, is the area 311′ where parts 28′ may be picked by robot 30 using the image and visual pick-up system of the embodiments described herein. Thus, the system 10 and method may use a single driven component for driving parts 28′ and causing parts 28′ that are not properly oriented for picking by the robot 30 to be recirculated, without the use of extra motors, movers, belts and the like.

The embodiment illustrated in FIGS. 1-18 provides the user with the ability to quickly change the picking surface or picking plates 44 and 204′ and to select a surface that is desirable for processing the parts. As mentioned earlier herein, the user may pick a surface that is textured, non-textured, compressible, non-compressible, transparent, opaque, non-opaque, hard, soft or that can be used for calibrating the image system.

### Additional Observations and Considerations

Several additional considerations, points of consideration and description are as follows:

1. Before operation, it may be desirable to remove all production parts from the system that are not the desired model. Although a few parts that are not the current model will not be noticed due to pattern mismatch, it is still a good idea to keep the feeder 14 clear of unwanted parts for improved recycle time. However, it should be understood that junk parts can stay in feeding bowl 18 and the system 10 will still function. This facilitates using the system 10 with multiple types of parts 28, without having to change out the feeding bowl 18 in response to the parts 28.

A removable clean out chute or door 121 (which is only shown in FIG. 4, for ease of illustration) may be provided for removing parts 28 from feeding bowl 18. By loosening the forward screw 152 and removing the rear screw 154, the door 150 pivots open, and the feeding bowl 18 can be emptied. By vibrating the feeding bowl 18, the parts 28 are vibrated out of the feeder 14. Any remaining parts 28 can be removed by hand. Advantageously, with a fully exposed access to the front area (as viewed in FIG. 1) of the feeding bowl 18 and picking surface or picking plate 44, the clean out of the feeding bowl 18 is easy and all parts are accessible.

Various parts require different surfaces to pick from. A directional mat surface 44b is the most versatile as it holds round parts still and provides a small amount of compliance for tight parts. As mentioned earlier, the picking surface or picking plate 44 may be replaced by removing the four thumb nuts 62 (FIG. 6) by hand, and replacing it with another plate 44 or the calibration plate 110. In the alternate embodiment shown in FIG. 15A, the picking surface or picking plate 44 comprises the plurality of resilient clips 204b′ that can enable or permit the picking surface or picking plate 44 to be removeably secured to the wall 210′, thereby permitting the user to easily change out the picking surface or picking plate 44 in response to lighting, the parts 28 being processed and the like.

The feeding gate 71 is adjusted to provide a good flow of parts for the vision-based pickup. Proper settings are achieved through experience. Flooding the picking surface 44 with parts 28 sometimes creates less pick-able parts 28 due to overlap. Closing the gate 71 off too much may inhibit the cycle time for feeding enough pickable parts.

Large volumes of parts 28 can be loaded in the feed hopper 20. Smaller volumes can be poured directly into the feeding bowl 18. The feeder 14 will self feed from the feed hopper 20 when it detects a shortage of parts 28 in the feeding bowl 18 using the sensor 74. It should be understood, however, that the feed hopper 20 is optional and the parts 28 may be feed manually or by other means directly into the feeding bowl 18.

Advantageously, the feeding bowl 18 is a fixed tooled item, which shakes or vibrates. For that reason, the parts 28 sitting in it never pass over relative moving surfaces such as transition from one belt to another, or transfer out into a bucket, etc. This improves the ability to move parts 28, while improving the life of the system 10 avoiding jams and maintenance wear zones.

Since the feeding bowl 18 is moved with a simple electromagnet operation of the system that requires minimal controls. Other prior art systems use two or three conveyors or shake feeders in linear directions, then have a dump bucket to get parts back to the upper elevation. The system 10 disclosed herein takes advantage of the corkscrew or helical path of the ramp 46 to provide full recirculation. The full recirculation is advantageously accomplished with a single actuation device.

By moving parts onto a flat, non-rotating surface 44a it is possible to use surfaces that hold round parts 28 still. This feeding technology accommodates everything from ball bearings to cylindrical objects like pencil erasers and metal slugs. As mentioned earlier, the use of a textured surface keeps round parts from undesired rolling.

By having a replaceable picking surface or picking plate 44 as the feeding surface 44a, easy change-out for various product styles is provided. A prior art belt style pickup would require removal, and replacement of a belt which is not a trivial changeover. Tool-less changeover of the picking surface or picking plate 44 provides the ability to use different colors or different surface properties to aid in part stabilizing, or in vision background. As mentioned earlier, if white parts are being picked up, a black picking plate 44 may be used. If black parts are being picked, a white picking plate 44 may be used, etc. If round parts are being run, then the Brushlon® (carpet) or other textured style pickup plate may be desired as mentioned earlier. If cubes are the parts, the solid surface plate may be used.

The use and arrangement of a top feed plate 44 and the parts reservoir 40 below it provides full access to the picking surface 44a of the feeder 14. Some prior art systems had robot interference problems with the part reservoirs, and especially where parts were housed in picking areas with side walls (not shown), which made it difficult for the robot to access the parts. Looking at the present feeder 14 (see FIGS. 1 and 2), there is no obstruction of any kind to get at the parts 28 with the exception of the 30 degrees or so of space where the parts 28 feed in from the feed hopper 20. Notice that a front side, where the robot accesses the feeder 14, is wide open.

Notice that the ramp 46 is approximately a 360 degree spiral, but it could be less than 360 degrees as is illustrated in the embodiment shown in FIGS. 15A and 16C, which is less than 360 degrees and closer to 270 degrees. By having a 360 degree spiral for bringing the parts 28 to the top picking plate 44, and a picking plate 44 and ramp 46 fabricated with ramp walls around the perimeter, a feeding bowl 18 can be provided which will insure that there are no areas where parts 28 can hide or get trapped underneath the spiral ramp 46 area exists for about 180° and an area underneath of the picking plate 44 exists. These are areas where parts 28 can get lost, or worse yet, long parts can jam. When there is full vertical clearance so that no useable space on the feeding bowl 18 is in a shadow, then it will be impossible for parts 28 to jam through the feeding process. The embodiment illustrated relative to FIGS. 15A-17D illustrates the use of an interior wall 210′ described below, and FIG. 19A illustrates another approach to preventing parts 28 from becoming trapped underneath the ramp 46. This will provide a safer range of parts to feed. This will also simplify bowl cleanout because it will have easy access.

It is not uncommon to have robots speak directly to cameras for point pickup information. It is also not uncommon for robots 30 to interact with feeding devices to manage parts entering and exiting a workspace. In contrast, the present embodiment herein discloses a more tightly integrated collection where the robot 30 can initiate camera triggers when it needs to recapture an image, or the feed controller 12 itself trigger images when and while parts are feeding so that it stops feeding only when it knows parts are available.

As mentioned earlier, there are three processors involved (feed controller 12, image controller 36 and robot controller 34), all of which speak to each other as mentioned earlier. The camera 24 and robot 30 are coupled for picture taking, and part pickup information. The camera 24 and the feed controller 12 are integrated for picture taking, and reporting back from the camera 24 that parts are in sight. The robot 30 and the feed controller 12 are coupled for the management of readiness for entrance to the feeder 14, and the request from the robot 30 to feed more parts 28. Since each shares access to each other, the ability to parallel process and have one-one interaction when required is all possible. This provides a most efficient robot 30 motion and feeding cycle time.

The following are some objects, features and advantages, which should be apparent, some of which were mentioned earlier and are worthy of repeating:
The system 10 provides large part storage capacity for unattended operation.
The system 10 provides continuous recirculation that presents a greater number of optimally oriented parts 28.
The feeder 14 has no moving parts which results in greater reliability.
A predetermined surface, such as a textured surface or surface that is compressible (See FIG. 1), non-compressible (See FIG. 18), hard, opaque, non-opaque, transparent, non-transparent, durable. For example, if a soft textured surface was desired, then the Brushlon® pickup surface 44a facilitates preventing parts 28 from rolling.
System 10 vibration can be tuned for optimal part 28 orientation.
High resolution camera 24 and lighting to differentiate small features on the target part 28a.
Designed to use MelfaVision® software which couples a Mitsubishi® robot with conventional vision products available from Cognex Corporation of Natick, Mass. within the robot program, which is generally easy to use and easy to program.
The system 10 can be used with many conventional robots, not just a Mitsubishi® brand robot.
Quick clean out door 120 provides for fast part changeover and this is cleanout is further facilitated by the embodiment shown in FIGS. 15A-17C wherein the picking surface or picking plate 204′ can be removed and parts 28 caused to drop or fall through aperture 216′ in the bottom 206a′ of the feeding bowl 200′.
Can accommodate an infinite variety of parts, especially parts up to 50 mm in length. Larger or smaller scale versions of the system 10 may be provided to process larger or smaller parts, respectively.
In the illustration, the feeding bowl 18 is made of stainless steel, and is approximately 21 inches in diameter. Sound deadening material may be used. The ramp 46 in the illustration in FIG. 1 is approximately 360 degrees, but could be less than 360 degrees, as illustrated in the embodiment of FIGS. 15A and 16C, where the ramp 46′ is approximately 270 degrees. The picking surface or picking plate 204′ in the illustration of FIG. 15A is approximately 4 inches by 6 inches and defines the picking area, which can be adapted to correspond to the field of view of the camera 24. The picking surface or picking plate 44 in the illustrative embodiment of FIG. 3 is larger and semicircular as shown, but provides adequate picking area that is generally larger than the field of view of the camera 24 as illustrated in FIGS. 14A and 14B.

### System Adjustments

The following are some typical system 10 adjustments that may be preformed prior to feeding and all settings can be controlled with a graphical user interface.

1) Hopper Gate—control flow based on part size.

2) Hopper Vibration Amplitude (Feeding Force) is set by the user using interface 54.

3) Hopper On Time—feeds parts for “N” seconds while main bowl is feeding if part sensor detects low level in bowl. Where “N”≦bowl feeding time.

4) Bowl Resonant Frequency Self Tuning—by detecting the bowls natural frequency using the accelerometer 52 we are able to feed a wider variety of parts since it will self optimize the drive.

5) Bowl Vibration Amplitude—(Feeding Force) is set by the user using interface 54.

6) Bowl On Time—when the system 10 calls for parts 28, this is the amount of time to cause the first vibratory drive 50 to vibrate before settle and re-image.

7) Bowl Settle Time—sometimes it is important to delay slightly before triggering the camera 24 after vibration stops. Heavy round parts 28 require slightly more time.

8) Feed Control Gate Angle—by using gate 71 to pinch off the feed to the picking plate 44, part separation can be controlled for easier part pickup.

9) Feed Plate Style and Selection—different colors and surface treatments are used for improved part location and image contrast.

10) Lighting Style—indirect diffuse white, polarized red or other. As mentioned earlier, different parts 28 required different lighting to accent desired features. As described earlier relative to FIG. 17C, backlighting of the picking surface or picking plate 204′ may be provided with the light source 212′.

11) The system 10 provides for continuous path circulation and recirculation.

12) The feeding bowl 18 may have sound absorption and/or deadening material (not shown) mounted on the cylindrical floor 19 if desired.

The following is a table listing several illustrative parts 28, but it should be understood that other parts, components and suppliers may be used without departing from the spirit and scope of the invention.

| Part Number | Part | Description | Manufacturer and City |
|---|---|---|---|
| 22 | Imaging Components | | Crescent Electric |
| | | | Supply |
| | | | Dayton, Ohio |
| 24 | IS-5401-10 n-Sight | Hi-Res Sensor/ | Crescent Electric |
| | | PatMax | Supply |
| | | | Dayton, Ohio |
| 246 | CIO-1400 | I/O Expansion | Crescent Electric |
| | | Module | Supply |
| | | | Dayton, Ohio |
| 26b | IQRL-109028 CCS | Red Bar Light | Crescent Electric |
| | QL | 109 × 28.5 mm | Supply |
| | | | Dayton, Ohio |
| 24b | IC00PL25NL | Polarizing Lens | Crescent Electric |
| | | Cover for camera | Supply |
| | | 24 | Dayton, Ohio |
| 24 | LFC | Fujinon Lens 9 mm-35 mm | Crescent Electric |
| | | | Supply |
| | | | Dayton, Ohio |
| 26b1 | | Polarizing filter or | Crescent Electric |
| | | film (optional) | Supply |
| | | | Dayton, Ohio |
| 18 | Feeder Bowl | | Service Engineering |
| | | | Greenfield, Indiana |
| 50b | Coil 25-1020 | 115 Volt Coil | Service Engineering |
| | | | Greenfield, Indiana |
| 20 | Hopper | | Service Engineering |
| | | | Greenfield, Indiana |
| 70b | Coil 45-1 | 115 Volt Coil | |
| | Photo-Optics & | | Crescent Electric |
| | Controllers | | Supply |
| | | | Dayton, Ohio |
| 74 | Banner QS30AFQ | DC Sensor | |
| 70 | SEI ST-1990-OFK | Accu-Feed | |
| | | Controller | |
| 50 | AT-1050-OFK-DP-P- | Accu-Tune | |
| | MMS | Controller | |
| 62 | Threaded Phenolic | 4273T84 | McMaster Carr |
| | Knobs | | Cleveland, Ohio |
| 71 | Stainless Steel | 8517A59 | McMaster Carr |
| | Protractor | | Cleveland, Ohio |

The program subroutines, vision tools and associated manuals embodied in or related to the MelfaVision® software available from Mitsubishi Electric Automation, Inc. of Vernon Hills, Ill. or the assignee hereof, Rixan Associates, Inc. may be used to facilitate image capture and processing of parts 28. For example, such programs and information may be used to manage multiple parts detected in a camera image from a subroutine perspective and to provide cleaner main program implementation of the overall cell process.

While the systems, methods and various embodiments described herein constitute preferred embodiments of this invention, it is to be understood that the invention is not limited to this precise apparatus and method, and that changes may be made in either without departing from the scope of the invention, which is defined in the appended claims.

What is claimed is:

1. A system for feeding parts comprising:
at least one controller;
a part feeder having a reservoir area and a picking area, said picking area being an area for supporting parts to be picked;
a robot coupled to said at least one controller and having an arm for picking at least one properly-oriented part at said picking area;
at least one recirculator for causing parts to be fed from said reservoir area to said picking area; and
an imaging system coupled to said at least one controller for capturing at least one image of said picking area and generating image data in response thereto;
said at least one controller energizing said at least one recirculator in response to said image data to cause parts to move to said picking area during a part feeding period and thereafter energizes said imaging system to capture at least one subsequent image of said picking area and generate said image data in response thereto;
said at least one controller using said image data to determine if said at least one properly-oriented part is located at said picking area and if it is, energizing said robot to cause said arm to pick said at least one properly-oriented part in response thereto and transfer it from said picking area to a part drop-off area;
wherein said at least one recirculator causes said parts to first move from said reservoir area to said picking area and for those parts that are not properly oriented at said picking area to be recirculated from said picking area to said reservoir area.

2. The system as recited in claim 1 wherein said at least one recirculator comprises at least one vibrator for vibrating said parts and causing them to move from said reservoir area to said picking area and for those parts that are not properly oriented at said picking area to be recirculated from said picking area to said reservoir area.

3. The system as recited in claim 1 wherein said part feeder comprises a driven member coupled to a driver for causing parts to be moved from said reservoir area to said picking area defining a picking surface and from said picking surface to said reservoir area.

4. The system as recited in claim 3 wherein said driven member comprises at least one ramp and said driver comprises at least one vibrator for vibrating said ramp to cause parts to vibrate and move on said ramp from said reservoir area to said picking surface and from said picking surface to said reservoir area.

5. The system as recited in claim 4 wherein said driven member comprises at least one belt and said driver comprises at least one belt driver for driving said at least one belt to transporting parts from said reservoir area to said picking surface and from said picking surface to said reservoir area.

6. The system as recited in claim 5 wherein an area of said at least one belt defines said picking surface.

7. The system as recited in claim 2 wherein said part feeder comprises:
a bowl adapted to define said reservoir area for said parts to be picked;
a ramp in said bowl for feeding parts from said reservoir area to said picking area;
said at least one vibrator vibrating both said ramp and said bowl during said part feeding period.

8. The system as recited in claim 2 wherein said part feeder further comprises a pick-off plate at said picking area, said pick-off plate receiving and supporting parts to be picked.

9. The system as recited in claim 8 wherein said pick-off plate comprises an edge over which parts may pass during vibration and be recirculated into said reservoir area.

10. The system as recited in claim 9 wherein said edge is situated entirely above said reservoir area.

11. The system as recited in claim 8 wherein said pick-off plate is situated above said reservoir area,
said pick-off plate being adapted to permit parts that are not properly oriented for picking at said picking area to fall by gravity into said reservoir area.

12. The system as recited in claim 8 wherein said pick-off plate is removably secured to said part feeder.

13. The system as recited in claim 8 wherein said pick-off plate is interchangeable with at least one second pick-off plate selected in response to the parts being picked.

14. The system as recited in claim 8 wherein said pick-off plate comprises a surface that supports said parts, said surface being adapted to improve at least one of movement of parts on said surface or imaging of parts on said surface.

15. The system as recited in claim 14 wherein said surface comprises a stainless steel plate, translucent polycarbonate, Brushlon, hard anodized aluminum, foam, or textured surface.

16. The system as recited in claim 14 wherein said surface comprises a predetermined color to facilitate capturing said at least one image.

17. The system as recited in claim 16 wherein said predetermined color comprises black, silver, white or translucent to facilitate grayscale contrast.

18. The system as recited in claim 8 wherein said pick-off plate comprises a surface adapted to improve both movement of parts on said surface and imaging of parts on said surface.

19. The system as recited in claim 7 wherein said ramp defines a helix and comprises an inlet associated with said reservoir area and an outlet in operative relationship with said picking area, with said outlet being vertically higher than said inlet;
said at least one vibrator causing said parts to travel by vibration from said reservoir area into said inlet, along said ramp where said parts can exit said outlet to said picking area.

20. The system as recited in claim 19 wherein said picking area comprises a pick-off plate, said system comprising a feed control for controlling flow of parts onto said pick-off plate.

21. The system as recited in claim 1 wherein at least some of said parts include parts, other than said at least one properly-oriented part, that are not picked by said robot and recirculated to said reservoir area.

22. The system as recited in claim 8 wherein said pick-off plate is translucent or non-opaque, and said imaging system comprises a light source that illuminates said pick-off plate from underneath said pick-off plate.

23. The system as recited in claim 22 wherein said at least one light source illuminates said picking area from underneath said picking area.

24. The system as recited in claim 2 wherein said at least one controller causes said imaging system to capture said image data of said picking area in response to a feed request from said robot and if said at least one properly-oriented part is not located at said picking area, said at least one controller energizes said at least one vibrator for a predetermined vibration period.

25. The system as recited in claim 24 wherein after said predetermined vibration period, said at least one controller causes said imaging system to capture another image of said picking area and if said at one properly-oriented part is situated at said picking area, said at least one controller ceases energizing said at least one vibrator.

26. The system as recited in claim 1 wherein said at least one controller comprises an auto mode during which it energizes said imaging system to capture said at least one image of said picking area at predetermined intervals and provides associated image data to said robot.

27. The system as recited in claim 2 wherein said at least one controller comprises a robot controller for controlling said robot, said robot controller causing said imaging system to capture said at least one image and generating a feed request signal in response thereto if no properly-oriented part is located at said picking area, and said at least one controller energizing said at least one vibrator in response to said feed request signal.

28. A system for feeding parts comprising:
a feeder bowl, said feeder bowl having a reservoir area for receiving parts, a picking surface and a ramp coupling said reservoir area to said picking surface;
at least one vibrator coupled to said feeder bowl for vibrating said feeder bowl to cause parts to move on said ramp from said reservoir area to said picking surface;
an imaging system for capturing at least one image of said picking surface and generating image data in response thereto; and
a robot for picking predetermined ones of said parts from said picking surface in response to said image data;
said picking surface being adapted and situated relative to said reservoir area so that at least some parts on said picking surface that are not said predetermined ones of said parts are recirculated into said reservoir area during vibration of said feeder bowl;
said picking surface comprises an edge over which parts may fall, said edge being contained within an imaginary plane of at least one reservoir wall defining said reservoir area;
said picking surface is generally planar and situated entirely above said reservoir area so that parts may fall off of said picking surface and recirculate into said reservoir area.

29. The system as recited in claim 28 wherein said system further comprises:
at least one controller coupled to said robot, said imaging system and said at least one vibrator for energizing said at least one vibrator to vibrate said feeder bowl during a part feeding period and cease energizing said at least one vibrator in response to image data that indicates that said predetermined ones of said parts are situated on said picking surface.

30. The system as recited in claim 29 wherein said imaging system captures at least one subsequent image of said picking surface and generates subsequent image data for each of said at least one subsequent image in response thereto;
said robot receiving said subsequent image data and in response, picks another one of said predetermined ones of said parts from said picking surface in response thereto or generates a request to feed signal if no predetermined ones of said parts are on said picking surface.

31. The system as recited in claim 28 wherein said predetermined ones of said parts comprise a predetermined characteristic.

32. The system as recited in claim 31 wherein said predetermined characteristic is at least one of a proper orientation, a part size or a part shape.

33. The system as recited in claim 30 wherein said controller energizes said at least one vibrator said imaging system to capture at least one second image and generate subsequent image data in response thereto after said robot has picked said at least one of said predetermined ones of said parts;
said robot receiving said subsequent image data and in response, picking another one of said predetermined ones of said parts.

34. The system as recited in claim 28 wherein said picking surface is removably secured to said feeder bowl.

35. The system as recited in claim 34 wherein said picking surface is interchangeable with at least one second picking surface selected in response to the parts being picked.

36. The system as recited in claim 28 wherein said picking surface comprises a preselected surface adapted to improve at least one of movement of parts on said picking surface or imaging of parts on said picking surface.

37. The system as recited in claim 36 wherein said preselected surface comprises a stainless steel plate, translucent polycarbonate, Brushlon, hard anodized aluminum, foam, or textured surface.

38. The system as recited in claim 36 wherein said preselected surface comprises a predetermined color to facilitate capturing said at least one image.

39. The system as recited in claim 38 wherein said predetermined color comprises black, silver, white or translucent to facilitate grayscale contrast

40. The system as recited in claim 36 wherein said picking surface comprises a surface adapted to improve both movement of parts on said surface and imaging of parts on said surface.

41. The system as recited in claim 28 wherein said ramp defines a helix and comprises an inlet associated with said reservoir area and an outlet in operative relationship with said picking surface, wherein said picking surface is higher than said inlet;
said at least one vibrator causing said parts to travel by vibration from said reservoir area into said inlet, along said ramp where then can exit said outlet and onto said picking surface.

42. The system as recited in claim 28 wherein said system further comprises a feed control for controlling flow of parts from said ramp onto said picking surface.

43. The system as recited in claim 42 wherein said feed control comprises an adjustable feeder gate in operative relationship with said outlet of said ramp.

44. The system as recited in claim 28 wherein said parts being processed do not comprise the same characteristics.

45. The system as recited in claim 28 wherein said picking surface is translucent or non-opaque, and said imaging system comprises a light source that illuminates said picking surface from underneath said picking surface.

46. The system as recited in claim 28 wherein at least one controller causes said imaging system to capture an image of said picking surface in response to a feed request from said robot and if said predetermined ones of said parts are not located at said picking surface, said at least one controller energizes said at least one vibrator for a predetermined vibration period to cause parts to be moved to said picking surface.

47. The system as recited in claim 46 wherein after said predetermined vibration period, said at least one controller causes said imaging system to capture another image of said picking surface and if at least one of said predetermined ones of said parts are situated on said picking surface, said at least one controller ceases energizing said at least one vibrator.

48. The system as recited in claim 28 wherein said system comprises at least one controller, said at least one controller comprising an auto mode during which it energizes said imaging system to capture said at least one image of said picking surface at predetermined intervals and provides said image data to said robot.

49. The system as recited in claim 28 wherein said system comprises at least one controller and a robot controller coupled to said at least one controller for controlling said robot, said robot controller causing said imaging system to capture said at least one image and generating a feed request signal in response thereto if no predetermined ones of said parts are located on said picking surface and said at least one controller energizing said at least one vibrator in response thereto.

50. A part feeder for use with a robot and an imaging system, said part feeder comprising:
a feeder bowl, said feeder bowl having a reservoir area for receiving parts, a picking surface and a ramp coupling said reservoir area to said picking surface;
at least one recirculator for causing parts to move from said reservoir area to said picking surface and to cause at least some parts on said picking surface that are not picked by the robot to move and recirculate into said reservoir area.

51. The system as recited in claim 50 wherein said at least one recirculator comprises at least one vibrator for vibrating said parts and causing them to move from said reservoir area to said picking surface and for those parts that are not properly oriented at said picking surface to be recirculated from said picking surface to said reservoir area.

52. The system as recited in claim 50 wherein said part feeder comprises a driven member coupled to a driver for causing parts to be moved from said reservoir area to said picking surface and from said picking surface to said reservoir area.

53. The system as recited in claim 52 wherein said driven member comprises at least one ramp and said driver comprises at least one vibrator for vibrating the ramp to cause parts to vibrate and move on said ramp from said reservoir area to said picking surface and from said picking surface to said reservoir area.

54. The system as recited in claim 50 wherein said picking surface comprises an edge over which parts may fall, said edge being contained within an imaginary plane of at least one reservoir wall defining said reservoir area.

55. The system as recited in claim 50 wherein said picking surface is generally planar and situated entirely above said reservoir area so that parts may fall off of and recirculate into said reservoir area.

56. The part feeder as recited in claim 50 wherein said part feeder further comprises an image system for imaging said picking surface and for using said image to determine if parts are available for picking by the robot.

57. A method for feeding and reticulating parts to a robot comprising the steps of:
providing a feeder bowl having a reservoir and a picking surface generally above the reservoir;
causing parts to move from said reservoir to said picking surface; and
causing the parts on said picking surface that are not picked by the robot to recirculate or fall off said picking surface into said reservoir.

58. The method as recited in claim 57, wherein said first causing step comprises the step of:
vibrating said picking surface.

59. The method as recited in claim 57, wherein said method further comprises the step of:
driving said parts from said reservoir to said picking surface.

60. The method as recited in claim 59, wherein said method further comprises the step of:
performing said driving and said causing steps using a belt.

61. The method as recited in claim 57 wherein said method further comprises the steps of:
providing a ramp between said reservoir and said picking surface;
causing said parts in said reservoir to move on said ramp to said picking surface.

62. The method as recited in claim 61 wherein said method further comprises the step of:
vibrating said bowl to cause parts to both move on said ramp and to recirculate or fall from said picking surface to said reservoir.

63. The method as recited in claim 57 wherein said method comprises the step of performing said providing and causing step without differentiating or identifying the parts that fall or recirculate off said picking surface.

64. The method as recited in claim 57 wherein said method further comprises the step of:
imaging said picking surface and generating image data correspondence thereto and using said image data to determine if parts are available for picking.
